(19) United States
(12) Patent Application Publication
(10) Pub. No.: US 2025/0080708 A1
(43) Pub. Date: Mar. 6, 2025

(54) DIGITAL IMAGE PROCESSING

(71) Applicant: Nahum Nir, Tel Aviv (IL)

(72) Inventor: Nahum Nir, Tel Aviv (IL)

(21) Appl. No.: 18/827,648

(22) Filed: Sep. 6, 2024

Related U.S. Application Data
(60) Provisional application No. 63/536,808, filed on Sep. 6, 2023.

(51) Int. Cl. H04N 9/77

(52) U.S. Cl. CPC H04N 9/77

(57) ABSTRACT

A method, computing system and apparatus for processing an image based on a luminance digital image. The method comprising: obtaining a Y group comprising one or more Y video virtual channels, wherein a Y video virtual channel comprised by the Y group is associated with a digital luminance representation of the image, wherein the Y video virtual channel comprises a plurality of luminance values, wherein a luminance value comprised by the plurality of luminance values is indicative to an intensity of luminance in one or more coordinates in the image; luminance processing a luminance based input to a luminance based output, wherein the luminance based input comprises the Y group, wherein luminance processing comprises utilizing a digital image processing algorithm with an input comprising the luminance based input, whereby processing the image based on the plurality of luminance values; and utilizing the luminance based output.

### CROSS REFERENCE TO RELATED APPLICATION

This application claims the benefit of provisional patent applications No. 63/536,808 filed Sep. 6, 2023, titled “DIGITAL IMAGE PROCESSING”, which is hereby incorporated by reference in its entirety without giving rise to disavowment.

### TECHNICAL FIELD

The present disclosure relates to digital image processing in general, and to processing one or more digital images by a computerized apparatus, in particular.

### BACKGROUND

In some standard embodiments, digital image processing may refer to a use of a computerized apparatus to process one or more digital images. In some standard embodiments, digital image processing may comprise applying a signal processing algorithm. Additionally or alternatively, a digital image may be a digital color image. A digital color image may be a digital image in an RGB format, in a BGR format, in a BGRA format, or the like. Additionally or alternatively, a digital image may be in a YUV format, in a Y′CbCr format, or the like.

In some standard embodiments, digital image processing may comprise color analyzing a digital image. Additionally or alternatively, color analyzing the digital image may comprise finding objects that are not visible in the digital image, such as a child playing hide and seek, wherein the child is behind a tree, detecting objects displayed in the digital image, sharpening the digital image, recognizing patterns displayed in the digital image, reconstructing the digital image, or the like. In some standard embodiments, a digital color image processing algorithm may be utilized in order to color analyze the digital image. The digital color image processing algorithm may be a color trained computer vision model, a color trained artificial neural network, a color trained machine learning algorithm, or the like. Additionally or alternatively, the color trained artificial neural network may be trained based on a plurality of digital color images. A digital color image may be an image comprising one or more video virtual channels, each of which may be associated with a color. As an example, the digital color image may be in a Red, Green, Blue (RGB) format. A first video virtual channel may comprise a plurality of values, each of which may indicate an intensity of blue in one or more coordinates in the digital color image. Similarly, a second video virtual channel may comprise a plurality of values, each of which may indicate an intensity of green in one or more coordinates in the digital color image. Additionally or alternatively, a third video virtual channel may comprise a plurality of values, each of which may indicate an intensity of red in one or more coordinates in the digital color image. In some standard embodiments, color training the artificial neural network based on the plurality of digital images may result in the color trained machine learning algorithm, in the color trained artificial neural network, in the color trained computer vision model, or the like. In some exemplary embodiments, a result of the training an artificial neural network may be referred to as weights. In some standard embodiments, the digital color image processing algorithm may be configured to color train the artificial neural network, to color train the computer vision model, or the like. In some standard embodiments, the color trained machine learning model may be configured to color process an input comprising an unseen digital image. The unseen digital image may not be comprised by the plurality of digital images used to color train the color machine learning algorithm. Additionally or alternatively, utilizing the color machine learning model to color analyze the digital image may comprise performing a matrix multiplication operation based on the digital image and based on the weights.

In some standard embodiments, digital image processing may comprise color processing a digital color image. Color processing the digital color image may comprise multiplying a matrix representing the digital color image with another matrix, performing a convolution on the matrix representing the digital color image, or the like.

In some standard embodiments, digital image processing may comprise color filtering a digital color image. Color filtering the digital color image may comprise blurring the digital color image, performing FFT on an input comprising the digital color image, or the like.

In some standard embodiments, digital image processing may comprise encoding a digital image, to an encoded digital image, decoding the encoded digital image, or the like.

In some standard embodiments, a computerized apparatus may be configured to train a computer vision model based on a dataset. A batch size may be indicative to a number of data items that may be stored in a RAM of the computerized apparatus. In some exemplary embodiments, a computer vision model may be trained based on the dataset. The dataset may comprise one or more digital images. Additionally or alternatively, training the computer vision model may comprise determining the batch size. The batch size may be determined based on a size of one or more data items comprised by the dataset. In some exemplary embodiments, the batch size may be bounded above by an available RAM size.

### BRIEF SUMMARY

One exemplary embodiment of the disclosed subject matter is a method comprising obtaining a Y group comprising one or more Y video virtual channels, wherein a Y video virtual channel comprised by the Y group is associated with a digital luminance representation of an image, wherein the Y video virtual channel comprises a plurality of luminance values, wherein a luminance value comprised by the plurality of luminance values is indicative to an intensity of luminance in one or more coordinates in the image; luminance processing a luminance based input to a luminance based output, wherein the luminance based input comprises the Y group, wherein luminance processing comprises utilizing a digital image processing algorithm with an input comprising the luminance based input, whereby processing the image based on the plurality of luminance values; and utilizing the luminance based output.

Optionally, the digital image processing algorithm is configured to process another input, wherein the other input comprises a number of video virtual channels, the method comprises obtaining a dummy group, wherein the dummy group is a group comprising another number of dummy virtual channels, wherein the other number of dummy virtual channels is equal to the number minus one, wherein the luminance based input comprises the dummy group, wherein a dummy video virtual channel comprised by the dummy group is selected from a group consisting one of: the Y virtual channel and a zero virtual channel, wherein the zero virtual channel comprises zeros, wherein the number of zeros is equal to the number of luminance's values comprised by the Y virtual channel, wherein the input comprises the Y group and the dummy group.

Optionally, the digital image processing algorithm is a digital color image processing algorithm configured to color process a color based input, wherein the color based input comprises a digital color representation of the image, wherein the digital color representation of the image comprises a color group, wherein the color group comprises one or more color video virtual channels, wherein color process the color based input comprises invoking the digital color image processing algorithm, wherein said luminance processing comprises invoking the digital color image processing algorithm with the luminance based input.

Optionally, the digital image processing algorithm is a digital color image processing algorithm configured to color process a color based input, the method comprises: modifying the digital image processing algorithm to a digital luminance image processing algorithm, wherein the luminance representation of the image comprises a single video virtual channel, wherein the single virtual channel is the Y video virtual channel.

Optionally, the digital image processing algorithm is a digital color image processing algorithm, the method comprises modifying the digital color image processing algorithm to a digital luminance image processing algorithm, wherein the digital luminance image processing algorithm is configured to process an input comprising a single video virtual channel, wherein the single video virtual channel comprises the Y group.

Optionally, obtaining the Y video virtual channel comprises: obtaining a digital image, wherein the digital image associated with a representation of the image, wherein the Y video virtual channel is based on the digital image.

Optionally, the luminance based output comprises a plurality of processed luminance values, wherein the luminance based output comprises an output digital luminance image, wherein the output digital luminance image comprises the plurality of processed luminance values and a plurality of chrominance values, wherein the output digital quasi image comprises an output luminance representation of the image.

Optionally, the plurality of chrominance values is based on the image.

Optionally, a first chrominance value comprised by the plurality of chrominance values is a constant, wherein the first chrominance value comprised by the plurality of chrominance values is equal to a second chrominance value comprised by the plurality of chrominance values.

Optionally, utilizing the luminance based output comprises providing the luminance based output to a user.

Optionally, another Y video virtual channel comprised by the Y group is associated with another digital luminance representation of another image.

Optionally, the digital image processing algorithm is configured to process another input, wherein the other input comprises a number of video virtual channels, wherein the digital image processing algorithm is configured to execute a sub processing operation once per each video virtual channel, the method comprises executing the sub processing operation once with an input comprising a single video virtual channel, wherein the single video virtual channel is the Y video virtual channel.

Another exemplary embodiment of the disclosed subject matter is a computing system comprising at least one processor; and at least one memory communicatively coupled to the at least one processor comprising computer readable instructions that when executed by the at least one processor cause the computing system to perform a method comprising obtaining a Y group comprising one or more Y video virtual channels, wherein a Y video virtual channel comprised by the Y group is associated with a digital luminance representation of an image, wherein the Y video virtual channel comprises a plurality of luminance values, wherein a luminance value comprised by the plurality of luminance values is indicative to an intensity of luminance in one or more coordinates in the image; luminance processing a luminance based input to a luminance based output, wherein the luminance based input comprises the Y group, wherein luminance processing comprises utilizing a digital image processing algorithm with an input comprising the luminance based input, whereby processing the image based on the plurality of luminance values; and utilizing the luminance based output.

Yet another exemplary embodiment of the disclosed subject matter is an apparatus comprising a processor and a memory; wherein the memory is configured to retain one or more video frames, wherein a video frame comprised by the one or more video frames comprises at least a first area of interest in the video frame; wherein said processor is configured to: obtaining a Y group comprising one or more Y video virtual channels, wherein a Y video virtual channel comprised by the Y group is associated with a digital luminance representation of an image, wherein the Y video virtual channel comprises a plurality of luminance values, wherein a luminance value comprised by the plurality of luminance values is indicative to an intensity of luminance in one or more coordinates in the image; luminance processing a luminance based input to a luminance based output, wherein the luminance based input comprises the Y group, wherein luminance processing comprises utilizing a digital image processing algorithm with an input comprising the luminance based input, whereby processing the image based on the plurality of luminance values; and utilizing the luminance based output.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter; and

FIG. 2 shows a block diagram of an apparatus, in accordance with some exemplary embodiments of the disclosed subject matter.

### DETAILED DESCRIPTION

One technical problem dealt by the disclosed subject matter is to process a group comprising one or more digital images. A digital image may be comprised by the group. In some exemplary embodiments, processing the digital image may comprise utilizing a digital image processing algorithm. In some exemplary embodiments, the digital image processing algorithm may be a digital filter. Additionally or alternatively, processing the digital image may comprise filtering the digital image, invoking the digital filter with the digital image as an input, or the like. Additionally or alternatively, processing the digital image may comprise applying the digital filter with an input comprising a portion of the digital image. In some exemplary embodiments, the digital filter may be a Gaussian filter, a median filter, Fast Fourier Transform (FFT), or the like.

In some exemplary embodiments, utilizing the digital image processing algorithm may comprise analyzing the digital image. Analyzing the digital image may comprise utilizing a trained computer vision model. In some cases, the digital image processing algorithm may be the trained computer vision model. Additionally or alternatively, processing the group of digital images may comprise training a computer vision model based thereon. Additionally or alternatively, processing the digital image may comprise applying a trained computer vision algorithm with an input comprising a portion of the digital image, improving a quality of the digital image, performing a convolution of the digital image and a kernel matrix, training the computer vision model, or the like. In some exemplary embodiments, the trained computer vision algorithm may comprise a YOLO model, may comprise an RCNN model, may comprise a Fast RCNN model, may comprise a Convolutional Neural Network (CNN) model, or the like.

In some exemplary embodiments, a digital image may represent an image. Additionally or alternatively, the digital image may comprise a digital representation of the image. Additionally or alternatively, the digital representation may comprise an intensity set. The intensity set may comprise a plurality of intensity values. Additionally or alternatively, an intensity value comprised by the intensity set may be a result of a measurement of an intensity of a visual quality in a coordinate in the image. As an example, a first digital representation of the image may be in an RGB format. In that case, the intensity value may be indicative of an intensity of red, of green, of blue, or the like, in the coordinate in the image. As another example, the digital image may be in a YUV format. In that case, the intensity value may be indicative of another intensity of luminance in the coordinate. Additionally or alternatively, another intensity value may be indicative of the intensity of a difference between a color measurement and a luminance measurement in the coordinates.

In some exemplary embodiments, there may be one or more representations of a measurement. Put differently, the intensity set may be associated with a format. In some exemplary embodiments, another digital image may represent the image in another format thus may be associated with another intensity set.

In some exemplary embodiments, a digital image may comprise a luminance portion. The digital image may be in a YUV format, in a Y′UV format, or the like. In that example, an intensity value comprised by an intensity set may represent a luminance intensity, or a function thereof, in a coordinate in the digital image. Additionally or alternatively, the intensity value may represent a chrominance intensity in one or more coordinates within the digital image. Additionally or alternatively, Y or Y′ may denote the luminance set. Additionally or alternatively, U or V may each denote a chrominance set. In some exemplary embodiments, the digital image may be associated with a width. Additionally or alternatively, the digital image may be associated with a height. Additionally or alternatively, the cardinality of the luminance set may be a product of the width and the height. The product may be denoted by W×H, wherein W may denote the width and h may denote the height. In some exemplary embodiments, a chrominance cardinality may be associated with yet another cardinality, the other cardinality may be indicative to another number of chrominance values comprised by one of the chrominance sets, such as U, V, or the like. The chrominance cardinality may be twice the cardinality of the luminance cardinality. Hence, the intensity cardinality may be three times the product of the width and the height. The intensity cardinality may be denoted by 3×W×H.

In some exemplary embodiments, the term YUV format may refer to Y′UV format, YCbCr format, Y′CbCr format, Y Pb/Cb Pr/Cr format, YCBCR format, Y′CBCR format, or the like.

In some exemplary embodiments, a digital image may represent an image. Additionally or alternatively, the digital image may be associated with an intensity set. The intensity set may be may be associated with an intensity cardinality. Additionally or alternatively, the intensity cardinality may represent a number of intensity values comprised by the intensity set. Similarly, another digital image may represent the image. Additionally or alternatively, the other digital image may be associated with another intensity set. The other intensity set may be associated with another intensity cardinality. The other cardinality may be smaller than the cardinality. It may be desired to process the image by utilizing the other digital image. Additionally or alternatively, it may be desired to process the digital image based on the other digital image. In some exemplary embodiments, the digital image may be in a format comprising three one or more color video virtual channels such as RGB, BGR, BGRA, or the like. Additionally or alternatively, the other digital image may be in a YUV format with subsampling such as YUV 4:2:0 (also known as YUV420), YUV 4:2:2 (also known as YUV422), or the like. In some cases, a human eye may be more sensitive to luminance than to chrominance. Hence, in some exemplary embodiments, the chrominance set may be subsampled, resulting in a smaller chrominance cardinality while maintaining a viewable quality of the digital image. Additionally or alternatively, the other digital image may be in a YUV 422 format yielding that the other cardinality may be 2×W×H. Additionally or alternatively, the other digital image may be in a YUV 420 format yielding that the other cardinality may be 1.5×W×H, or the like. In those examples, It may be desired to process the other digital image instead of processing the digital image.

In some exemplary embodiments, an intensity set may comprise a plurality of color values. The intensity set may be in a Red, Green, Blue (RGB) format, in a Blue, Green, Red (BGR) format, in a Red, Green, Blue, Alpha (RGBA) format, or the like. In that example, an intensity value comprised by the intensity set may represent a measurement of an intensity of a color in a coordinate in the image. Additionally or alternatively, the intensity set may comprise three or more color sets. Additionally or alternatively, an intensity cardinality may be C times the product of the width and the height, wherein C may denote the number of color sets. Additionally or alternatively, a cardinality of the intensity set may be C×W×H. Additionally or alternatively, the intensity value may be a hue value, a saturation value, a lightness value, or the like. In that case, the digital image may be in a hue, saturation lightness (HSL) format. Similarly, the digital image may be in hue, saturation brightness (HSV) format. Additionally or alternatively, the cardinality of the intensity set may be 3×W×H. Hence, it may be desired to process a digital image in a YUV format, in a Y′UV format, or the like.

Another technical problem dealt by the disclosed subject matter is to reduce a time needed to process a group comprising one or more digital images. The group may comprise at least a digital image. In some exemplary embodiments, it may be desired that the time needed to process the digital image may be below a threshold. As an example, the digital image may be comprised by a video stream comprising an online sport event, a film, or the like. Additionally or alternatively the video stream may be associated with a frames per second (FPS) parameter. The FPS parameter may indicate a number of digital images that should be displayed to a user within one second. The FPS parameter may be equal to 60, may be equal to 120, or the like. Additionally or alternatively, the FPS parameter may indicate the number of frames per second that may be available for processing. As an example, in the case that the FPS is 60, a camera may provide 60 frames per second. In some exemplary embodiments, the threshold may be smaller than 1/60 of a second, allowing processing each digital image.

In some exemplary embodiments, it may be desired to reduce a computational recourses needed to train a computer vision model. The computer vision model may be configured to analyze a digital image, to analyze an image, or the like. Analyzing the digital image may comprise detecting one or more objects displayed in the digital image, improving a quality of the digital image, determining landmarks of an object displayed in digital image, providing a live avatar of a person displayed in one or more digital images, or the like. Additionally or alternatively, training the computer vision model may comprise processing a plurality of digital images. The plurality of digital images may comprise 5,000 digital images, 10,000 digital images, 1,000,000 digital images, or the like. Additionally or alternatively, training the computer vision model may require one or more computerized devices, one or more GPUs, one or more CPU's, RAM, or the like. It may be desired to reduce the number of GPU's, the number of CPU's, the amount of RAM needed to train the computer vision model. Additionally or alternatively, it may be desired to reduce a time needed to train the computer vision model, time in which the computerized resources are being utilized.

Yet another technical problem dealt by the disclosed subject matter is to obtain a digital image in a ready format. In some exemplary embodiments, a digital image may be obtained in order to be processed. Additionally or alternatively, processing the digital image may comprise encoding the digital image, decoding the digital image, analyzing the digital image, applying a digital filter on the image, or the like. Additionally or alternatively, processing the digital image when represented in a ready format may yield better processing time compared to processing the digital image when represented in another format. Additionally or alternatively, processing the digital image when represented in the ready format may require less computational resources compared to when represented in the other format. It may be desired to obtain the digital image in the ready format instead of obtaining another digital image in the other format and converting the other digital image to the digital image in the ready format. As an example, a computerized apparatus may be configured to obtain a digital image. Additionally or alternatively, the computerized apparatus may be configured to process the digital image. Additionally or alternatively, the computerized apparatus may be configured to encode a processed digital image. The processed digital image may be a result of processing the digital image. It may be desired that the obtained digital image may be in the ready format. Additionally or alternatively, it may be desired to process the obtained digital image in the ready format, in a sub format of the ready format, or the like. Additionally or alternatively, it may be desired that encoding the digital image may be performed based on the ready format. In some exemplary embodiments, the sub format of the ready format may be comprised by the format. Additionally or alternatively, the digital image in the ready format may be associated with an intensity set comprising one or more video virtual channels. Additionally or alternatively, another digital image in the sub format may be associated with another intensity set comprising another group of one or more video virtual channels. The other group may be a subset of the group.

Yet another technical problem dealt by the disclosed subject matter is to luminance process one or more digital images based on a plurality of luminance values, based on a Y group, based on a plurality of digital luminance images, or the like.

Yet another technical problem dealt by the disclosed subject matter is to luminance train a luminance computer vision model based on a Y group. Additionally or alternatively, luminance training the luminance computer vision model may be based on one or more dummy values.

Yet another technical problem dealt with by the disclosed subject matter is provide a luminance dataset to a computerized apparatus configured to luminance train a digital luminance computer vision model. Additionally or alternatively, the luminance dataset may comprise a Y group, may comprise a plurality of digital luminance images, or the like. Additionally or alternatively, providing the luminance dataset may also comprise providing one or more dummy values.

Yet another technical problem dealt with by the disclosed subject matter is to increase a batch size. In some exemplary embodiments, utilizing a larger batch may permit an increased volume of data to be processed during each forward and backward pass through an artificial neural network comprised by a luminance computer vision model. As a result, a reduction in training times may be achieved, as the luminance processing process may be configured to avoid a necessity of waiting for a greater number of individual data points to be processed before progressing to the subsequent batch.

In some exemplary embodiments, utilizing a larger batch may improve a stability of luminance training a luminance computer vision model compared to training a computer vision model. In some exemplary embodiments, the larger batch may allow reducing a noise that may be caused by a Stochastic Gradient Descent (SGD), by a variant of the SGD, or the like. In some exemplary embodiments, averaging the gradients over a larger a plurality of digital luminance image may provide a more accurate estimate of a gradient direction, allowing a better convergence of a loss function. Additionally or alternatively, fewer oscillations in the loss function may be performed.

In some exemplary embodiments, utilizing a larger batch may yield a trained luminance computer vision model that may be capable to handle a noisy data, a data comprising an outlier, or the like. In some exemplary embodiments, as one or more gradients may be averaged over a larger number of digital luminance images, an individual noisy digital luminance image may have less impact on an overall gradient direction, allowing a faster completion of a luminance training a digital luminance computer vision model.

As an example, in some cases, a small batch may comprise 16 data items, 22 data items, 32 data items, or the like. Additionally or alternatively, a large batch may comprise 1024 data items, 2048 data items, 4096 data items, 3019 data items, or the like. In Accurate, Large Minibatch SGD: Training ImageNet in 1 Hour, Priya Goyal et al, show a training of a computer vision model utilizing a ResNet 50 model within an hour by utilizing a batch comprising 8192 data samples. Additionally or alternatively, the training required 256 GPUs. By utilizing the disclosed subject matter, it may be possible to luminance train a luminance computer vision model within another hour, within 55 minutes, with 70 minutes, or the like. Additionally or alternatively, the luminance training may require 85 GPUs, 86 GPUs, 128 GPUs, or the like.

Yet another technical problem dealt with by the disclosed subject matter is to encode one or more digital images based on a plurality of luminance values, based on a Y group, based on a plurality of digital luminance images, or the like. Additionally or alternatively, encoding a digital image may also be based on one or more dummy values.

One technical solution is to luminance process a digital luminance image. In some exemplary embodiments, a digital image may represent an image, may be associated with a digital representation of the image, or the like. In some exemplary embodiments the digital luminance image may be associated with a digital luminance representation of the image. Additionally or alternatively, the digital luminance image may represent the image based on a plurality of luminance values. Additionally or alternatively, an intensity set associated with the digital luminance image may be associated with the plurality of luminance values. Additionally or alternatively, the digital luminance image may be obtained based on the digital image. Additionally or alternatively, a cardinality of the intensity set may be W×H, wherein W may denote a width of the digital image and H may denote a height of the digital image. Additionally or alternatively, the digital luminance image may be luminance processed. Additionally or alternatively, luminance processing the digital luminance image may yield a luminance based output. In some exemplary embodiments, the luminance based output may be utilized by a user, may be provided to the user, or the like.

In some exemplary embodiments, a digital image may be obtained. The digital image may be obtained from a camera, from a file, or the like. Additionally or alternatively, the digital image may be associated with a digital representation of an image. In some exemplary embodiments, a digital luminance image may be obtained based on the digital image. As an example, the digital image may be obtained in a YUV format. Additionally or alternatively, the digital luminance image may comprise a Y portion of the digital image. As another example, the digital image may be a color digital image in an RGB format. Additionally or alternatively, the digital luminance image may be obtained based on the color digital image by utilizing a formula such as ***. Additionally or alternatively, the digital luminance image may be luminance processed.

In some exemplary embodiments, a digital image may be converted to a digital luminance image in order to luminance process the digital luminance image instead of processing the digital image. Additionally or alternatively, an intensity set comprised by the digital image may comprise one or more video virtual channels, each of which comprising one or more color values. Additionally or alternatively, a cardinality of the intensity set may be C times W times H (C×W×H), wherein C may denote a number of color video virtual channels, wherein W may denote a width associated with the digital image and wherein H may denote a height associated with the digital image.

As an example, processing an image may comprise detecting one or more objects displayed in the image. A digital image representing the image may be obtained. The digital image may be in a YUV format. Additionally or alternatively, detecting an object displayed in the image may comprise luminance detecting the object. In some exemplary embodiments, luminance detecting the object may be based on a plurality of luminance values. In some exemplary embodiments, luminance detecting the object may refer to executing a digital luminance computer vision model with an input comprising the digital luminance image. Additionally or alternatively, the plurality of luminance values may be comprised by the Y video virtual channel of the digital image. In that example, a luminance based output may comprise one or more coordinates in the digital image. A coordinate comprised by the one or more coordinates may be indicative of a location of the object in the image. Additionally or alternatively, utilizing the luminance based output may comprise plotting a coordinate on the digital image and rendering the digital image, allowing a user to view the digital image with the coordinate. Additionally or alternatively, the luminance based output may comprise a label associated with the object. The label may comprise text such as “dog”, “person”, “car”, “bus”, “fish”, or the like, indicating a class of the object. In some exemplary embodiments, the label may be plotted based on the coordinate on the digital image, may be rendered with the digital image, or the like, allowing the user to see the label near the object.

In some exemplary embodiments, processing a digital image may comprise luminance processing a digital luminance image. Luminance processing the digital luminance image may comprise invoking a digital luminance image processing algorithm with an input comprising the digital luminance image. In some exemplary embodiments, the digital luminance image processing algorithm may be a modified digital image processing algorithm. The digital image processing algorithm may be configured to process an input comprising a digital image. Additionally or alternatively, the luminance digital image processing algorithm may be configured to luminance process an input comprising the digital luminance image. Additionally or alternatively, the digital luminance image may comprise a single video virtual channel. The single video virtual channel may be associated with a plurality of luminance values. Additionally or alternatively, the digital luminance image processing algorithm may be configured to luminance process an input comprising a digital luminance representation of an image. The digital luminance representation of the image may be associated with the single video virtual channel. Additionally or alternatively, the single video virtual channel may be referenced as a Y video virtual channel.

In some exemplary embodiments, a digital image may be associated with an additional information such as a width of the image, a height of the image, a codec used to encode the digital image, a location indicating where a light sensor was utilized to capture the digital image, a time stamp indication when the image was captured, a user information comprising information about a user utilizing the light sensor, an information regarding the light sensor, or the like. Additionally or alternatively, a digital luminance image may be associated with the additional information.

In some exemplary embodiments, such as in a case in which a user is interested in analyzing an image rather than watching an image, a light sensor may be configured to capture a digital luminance image, wherein the digital luminance image may represent the image. The digital luminance image may be in a Y format, in a YX format, or the like. In case that the digital luminance image is in a Y format, the digital luminance image may comprise a single video virtual channel, a Y video virtual channel. Additionally or alternatively, in case that the digital luminance image is in a YX format, the digital luminance image may comprise one or more dummy video virtual channel. A dummy video virtual channel may be associated with the plurality of luminance values. As an example, a digital luminance image in a YY format may be associated with two Y video virtual channels, each of which may be associated with the plurality of luminance values. Additionally or alternatively, a dummy video virtual channel may be associated with a plurality of zero values. Additionally or alternatively, the dummy video virtual channel may be referred to as a zero video virtual channel. The zero video virtual channel may be a constant video virtual channel. Additionally or alternatively, the digital luminance image may be obtained from a luminance generative model, configured to generated the digital luminance image. Such configuration may be useful in case that a satisfactory visual appearance above a high threshold may not be required. As an example, a computerized apparatus may be configured to utilize the disclosed subject matter in order to analyze a Magnetic Resonance Imaging (MRI) image. An MRI scanner may be configured to provide the MRI image as a digital luminance image in the Y format. The digital luminance image in the Y format may be analyzed in order to find a brain disorder, a musculoskeletal disorder, a cardiovascular disorder, or the like. Similarly, in some exemplary embodiments, the disclosed subject matter may be utilized in order to detect one or more suspicious people. The computerized apparatus may be configured to obtain the digital luminance image in the Y format from a surveillance camera. Additionally or alternatively, the surveillance camera may be configured to provide the digital luminance image. Additionally or alternatively, the computerized apparatus may be configured to luminance analyze the digital luminance image in the Y format. In some exemplary embodiments, luminance analyzing the digital luminance image may comprise detecting one or more images of the one or more suspicious people in the digital luminance image. Additionally or alternatively, upon detecting such an image, the computerized apparatus may be configured to obtain a digital image in a YUV format, in an RGB format, or the like and to display the digital image to a user, wherein the digital image may show a suspicious person.

In some exemplary embodiments, a computerized apparatus may be configured to luminance process a digital luminance image. Additionally or alternatively, the computerized apparatus may be configured to display a digital image to a user. The digital image and the digital luminance image may both represent a same image. Additionally or alternatively, luminance processing the digital luminance image may be more important to the user than displaying the digital image. Additionally or alternatively, the computerized apparatus may be configured to perform a number of luminance processing operations. Additionally or alternatively, the computerized apparatus may be configured to display another number of digital image. The number may be larger than the other number. As an example, the computerized apparatus may be operatively coupled with a light sensor. Additionally or alternatively, the light sensor may be configured to produce one or more digital luminance images in a Y format followed by one or more digital images. In some exemplary embodiments, luminance processing the digital luminance image may comprise luminance analyzing the digital luminance image. Additionally or alternatively, the computerized apparatus may be configured to analyze a biopsy. In order to analyze the biopsy, the biopsy may be divided into one or more aliquot parts. Additionally or alternatively, an aliquot part may be associated with a depth of 80 micron, 10 micron, 5 micron, 2 micron, 1 micron, or the like. The aliquot part may be associated with the digital luminance image. The computerized apparatus may be configured to luminance analyze the aliquot part. Additionally or alternatively, the computerized apparatus may be configured to display the digital image, wherein the digital image may represent the aliquot part. Additionally or alternatively, as the human eye may not be able to see a difference between each aliquot part, the computerized apparatus may be configured to display one or more digital images at a first FPS parameter. Additionally or alternatively, the computerized apparatus may be configured to luminance analyze one or more digital luminance image at second FPS parameter. The second FPS parameter may be larger than the first FPS parameter. Additionally or alternatively, in case that abnormal cells were discovered while luminance analyzing a piece of the biopsy, an output digital luminance image displaying the piece may be displayed to a user analyzing the biopsy. The user may be a clinician, a research scientist, or the like.

In some exemplary embodiments, a digital luminance image may comprise a number of video virtual channels. The digital luminance image may comprise a Y video virtual channel comprising a plurality of luminance values. Additionally or alternatively, the digital luminance image may comprise one or more dummy video virtual channels comprising a plurality dummy values. In some exemplary embodiments a dummy video virtual channel comprising the plurality of luminance values may be equal to the Y video virtual channel. A digital luminance image comprising such dummy video virtual channels may be in a YY format, in a YYY format, or the like. Additionally or alternatively, a dummy video virtual channel may comprise one or more values equal to 0. In that case, the digital luminance image may be in a Y00 format, in a 0Y0 format, in a 00Y format, in an 0YY format, or the like.

In some exemplary embodiments, the digital luminance image may be in a YX format. Additionally or alternatively, the digital luminance image may comprise a Y video virtual channel and one or more dummy video virtual channels. X may denote the one or more dummy video virtual channels. Additionally or alternatively, the digital luminance image may be in a XY format.

In some exemplary embodiments, a digital luminance image processing algorithm may be identical to a digital image processing algorithm. Additionally or alternatively, a digital luminance image may be provided, as an input, to the digital luminance image processing algorithm. Additionally or alternatively, the digital image processing algorithm may be configured to process an input comprising one or more pluralities of color values. Additionally or alternatively, the input may comprise one or more video virtual channels, each of which may be associated with a color data. Never the less, the digital image processing algorithm may be provided with another input comprising a digital luminance image. Additionally or alternatively, the input may be associated with a digital color image. The digital color image and the digital luminance image may both represent a same image. In that case, the digital luminance image processing algorithm may provide a luminance based output as an output. Additionally or alternatively, the digital luminance image may be in a YX format. Additionally or alternatively, providing the digital luminance image in the YX format as an input may yield a same result as providing the digital color image as an input to the digital image processing algorithm. Additionally or alternatively, a difference between an output of the digital image processing algorithm and the luminance based output may be below a threshold. The digital color image may be in an RGB format, in a BGR format, or the like. Additionally or alternatively, X may denote a number of dummy video virtual channels. Additionally or alternatively, the digital image processing algorithm may be configured to process an input comprising another number of input channels. The number of dummy video virtual channels may be equal to the other number minus 1 (number=other number−1).

As an example, a digital image processing algorithm may be a trained color computer vision model. The trained color computer vision model may have been trained based on a plurality of digital color images in an RGB format. In some exemplary embodiments, the trained color computer vision model may be configured to color analyze an input comprising one or more digital color images in an RGB format. Nevertheless, a digital luminance image may be provided to the digital image processing algorithm for analyzation.

In some exemplary embodiments, a digital image processing algorithm may be configured to process a digital image. The digital image may comprise a number of video virtual channels. Additionally or alternatively, a first error value may be calculated based on an error function. Additionally or alternatively, a first input to the error function may comprise one or more outputs of the digital image processing algorithm. The first output may be based on a first group comprising one or more digital color images. Additionally or alternatively, the first output may comprise one or more color based outputs of the trained color computer vision model. Additionally or alternatively, the one or more color based outputs may be a result of analyzing the one or more digital color images by the trained color computer vision model. Additionally or alternatively, a second error value may be calculated based on the error function. A second input to the error function may comprise one or more digital luminance images in a YX format, where in x equals 2, yielding that the format may be a Y00 format, a YYY format, or the like. Additionally or alternatively, the second output may comprise one or more luminance based outputs of the trained color computer vision model. Additionally or alternatively, the one or more luminance based outputs may be a result of analyzing the one or more digital luminance images by the trained color computer vision model. In some exemplary embodiments, a difference between the first error value and the second error value may be below a threshold. Additionally or alternatively, a digital image comprised by the one or more digital images may be converted to a digital luminance image in the YX format, wherein X may denote two virtual video channels.

In some exemplary embodiments, a digital luminance image processing algorithm may be configured to output a luminance based output. Additionally or alternatively, the luminance based output may comprise an output digital luminance image. Additionally or alternatively, it may be desired that the output digital luminance image, may be associated with a satisfactory visual appearance. Additionally or alternatively the output digital luminance image may be in a Y format, wherein Y may denote a plurality of processed luminance values. Additionally or alternatively, the output digital luminance image may be associated with an un satisfactory visual appearance. Additionally or alternatively, adding a plurality of chrominance values to the luminance based output may yield the satisfactory visual appearance of the output digital luminance image. In some exemplary embodiments, a chrominance value comprised by the plurality of chrominance values may be indicative of a difference between a color value and a luminance value in one or more coordinates in the digital image. In some exemplary embodiments, the digital luminance image may be obtained based on a digital image. Additionally or alternatively, the plurality of chrominance values may be obtained based on the digital image.

In some exemplary embodiments, in order to estimate a performance of a luminance processing, a pre trained no reference image quality assessment (IQA) model may be utilized. The pre trained no reference IQA model may be a Blind Image Quality Assessment using Structural Similarity (BRIS QUE), Natural Image Quality Evaluator (NIQE), Perceptual Image Quality Evaluator (PIQE), Mean Opinion Score Calculation Algorithm (MOSCA), DeepIQA, Blind Image Quality Index (BIQI) Image Fidelity (IF), or the like. Additionally or alternatively, a digital luminance image may be luminance processed resulting in a luminance based output. Additionally or alternatively, the luminance based output may comprise an output digital luminance image. A portion of the output digital luminance image may be provided to the pre trained no reference IQA model. A first output value may be obtained from the pre trained no reference IQA model. The first output value may be a value between zero and one (0<=first output value<=one), wherein one may represent a perfect quality and zero may represent a lowest quality. In some exemplary embodiments, a digital image may be processed, resulting in an output. The output may comprise an output digital image. A portion of the output digital image may be provided to the pre trained no reference IQA model. A second output value may be obtained. The second output value may be between zero and one (0<=second output value<=one). In some exemplary embodiments, a difference between the first output value and the second output value may be below a threshold. The threshold may be 0.1, 0.2, 0.01, 0.015, 0.18, 0.0012, or the like, yielding that the output digital luminance image and the output digital image are both associated with a similar satisfactory visual appearance. In some exemplary embodiments, in order to estimate the performance of luminance processing, the output digital color image and the output digital luminance image may be provided to a Structural Similarity Index (SSIM). The output of the SSIM may be 0.9, 0.95, 0.87, 0.99, or the like. Additionally or alternatively, the output digital image and the output digital luminance image may be provided to a Gradient Magnitude Similarity Deviation (GMSD).

In some exemplary embodiments, in order to output a luminance based output comprising an output digital luminance image, a plurality of chrominance values may be obtained. Additionally or alternatively, the plurality of chrominance values may be added to the luminance based output, whereby providing the output digital luminance image in a YUV format. In some cases, the plurality of chrominance values may be obtained based on a digital image, wherein the digital image and the output digital image may represent a same image. Additionally or alternatively, obtaining the plurality of chrominance values may comprise setting a plurality of values to a constant value. In some exemplary embodiments, the constant value may be determined based on a digital luminance image processing algorithm.

As an example, a computerized apparatus may be configured to blur an image. In some exemplary embodiments, a digital image may be obtained based on an image, such as by taking a photo, by utilizing a webcam, a camera, or the like. Additionally or alternatively, a plurality of luminance values may be obtained based on the digital image. Additionally or alternatively, the plurality of luminance values may be obtained based on the digital image by utilizing a formula in order to convert one or more pluralities of color values to the plurality of luminance values. Additionally or alternatively, the plurality of luminance values may be luminance processed to a processed plurality of luminance values. In some exemplary embodiments, luminance processing the plurality of luminance values may comprise invoking a digital luminance filter with an input comprising the plurality of luminance values. Additionally or alternatively, the digital luminance filter may comprise a mask. Additionally or alternatively, invoking the digital luminance filter may comprise performing a convolution. Additionally or alternatively, the convolution may be performed based on the plurality of luminance values and based on the mask. In some exemplary embodiments, an output of the digital luminance filter may comprise a plurality of processed luminance values. Additionally or alternatively, the plurality of processed luminance values may be comprised by a luminance based output. Additionally or alternatively, in order to display a blurred version of the image, a plurality of chrominance values may be obtained based on the digital image. Additionally or alternatively, the plurality of chrominance values may be added to the luminance based output. As a result, the output digital luminance image may comprise the plurality of processed luminance values and the plurality of chrominance values. The output digital luminance image, when rendered, may display the blurred version of the image. Additionally or alternatively, the output digital luminance image may be associated with a satisfactory visual appearance compared to the digital image and based on the digital luminance filter.

In some exemplary embodiments, a digital luminance filter may be associated with a filtering parameter. Additionally or alternatively, the digital luminance filter may exhibit a substantial filtering effect when the filtering parameter is set to a high filtering value, whereas a low filtering value may yield a more lenient and effectless filtering process. Additionally or alternatively, in case that the filtering parameter is above a high filtering threshold, the filtering parameter may be associated with a high value. Additionally or alternatively, in case that the filtering parameter is below a low filtering threshold, the filtering parameter may be associated with a low value. As an example, the digital luminance filter may be configured to blur an image. Additionally or alternatively, the image may be represented by a digital luminance image. Additionally or alternatively, the digital luminance filter may be configured to luminance process an input comprising the digital luminance image. Additionally or alternatively, the filtering parameter may be associated with the high filtering value. Additionally or alternatively, executing the digital luminance filter with an input comprising the digital luminance image and based on the high filtering value may render the output digital luminance image unintelligible to a user. Additionally or alternatively, the output digital luminance image may be associated with a satisfactory visual appearance based on the filtering parameter. As another example, the filtering parameter may be associated with the low filtering value. Additionally or alternatively, the image may display a face of a person. Additionally or alternatively, the digital filter may be configured to blur the image. Additionally or alternatively, a user may be able to determine that the rendered output digital luminance image, may display the face. Additionally or alternatively, the output digital luminance image may be associated with a satisfactory visual appearance with respect to the image based on the filtering parameter.

In some exemplary embodiments, a digital image processing algorithm and a digital luminance image processing algorithm may be configured to perform a same task. In some exemplary embodiments, performing the same task may comprise invoking a digital filter with an input comprising a digital image or invoking a digital luminance filter with an input comprising a digital luminance image. As an example, the digital filter may be a gaussian filter and the digital luminance filter may be a luminance gaussian filter. The digital filter may be configured to process a digital image comprising three or more color video virtual channels, each of which may be associated with a color quality. Additionally or alternatively, the digital filter may be configured to repeat a gaussian filtering operation with each color video virtual channel as an input. Additionally or alternatively, the digital luminance filter may be configured to luminance process a digital luminance comprising a single video virtual channel, a Y video virtual channel. Additionally or alternatively, the digital luminance filter may be configured to perform a luminance gaussian filtering only once with the Y video virtual channel as an input. In some exemplary embodiments, as the digital image processing algorithm and the digital luminance image processing algorithm may be configured to perform the same task, a difference between the output and the luminance based output may be below a threshold. In some exemplary embodiments, the digital luminance image may comprise a dummy video virtual channel. In the case that the dummy video virtual channel is another Y video virtual channel, the other Y video virtual channel may be equal to the Y video virtual channel. Hence, the digital luminance filter may be configured to reuse a result of performing the gaussian filtering operation. Additionally or alternatively, the dummy video virtual channel may be a zero video virtual channel. In that case, the digital luminance filter may be configured to return one or more zero values instead of performing the gaussian filtering operation.

In some exemplary embodiments, a same task may refer to analyzing an image. The image may be analyzed based on a digital image representing the image. In some exemplary embodiments, the image may be luminance analyzed based on a digital luminance image representing the image. In some exemplary embodiments, processing the digital image may comprise analyzing the digital image. In some exemplary embodiments, a digital image processing algorithm may comprise a trained computer vision model configured to process an input comprising a digital image and to output an output. Additionally or alternatively, a digital luminance image processing algorithm may comprise a trained luminance computer vision model configured to luminance process an input comprising a digital luminance image and to output a luminance based output. In some exemplary embodiments, a difference between the output and the luminance based output may be below a threshold. Additionally or alternatively, the digital luminance image may be obtained based on the digital image. Additionally or alternatively, the same task may be to detect one or more objects displayed in the image, to find body landmarks of one or more persons displayed in the image, to digitally filter the image, or the like. In some exemplary embodiments, the output may comprise an output digital image. Additionally or alternatively, the luminance based output may comprise an output digital luminance image. Additionally or alternatively, the difference between the output and the luminance based output may be calculated by calculating a function measurement for evaluating the difference between the output digital image and the output digital luminance image. As an example, the function measurement may be Structural Similarity Index (SSIM). In that example the threshold may be 0.9, 0.95, 0.96, or the like.

As another example, a same task may comprise detecting one or more objects displayed in an image, in a digital image, in a digital luminance image, or the like. In some exemplary embodiments, a digital image processing algorithm may be configured to detect one or more objects based on the digital image. Additionally or alternatively, a digital luminance image processing algorithm may be configured to detect one or more objects based on the digital luminance image. A precision metric may be calculated based on the digital luminance image processing algorithm. Additionally or alternatively, another precision metric may be calculated based on the digital image processing algorithm. Another difference between a result of the precision metric and another result of the other precision metric may be below a third threshold. The third threshold may be 0.4 0.02, 0.1, or the like.

Another technical solution is to provide a trained luminance computer vision model. In some exemplary embodiments, providing the trained luminance computer vision model may comprise training a luminance computer vision mode. Training the luminance computer vision model may be based on a Y group. Additionally or alternatively, training the luminance computer vision model may also be based on one or more dummy values. In some exemplary embodiments, providing the trained luminance computer vision model may comprise modifying a computer vision model.

Yet another technical solution is to train a luminance computer vision model to a trained luminance computer vision model. In some exemplary embodiments, processing a plurality of digital luminance images may yield a trained luminance computer vision model. In some exemplary embodiments, the trained luminance computer vision model may be configured to luminance analyze a digital image based on a digital luminance image. In some exemplary embodiments, luminance training the luminance computer vision model may comprise luminance processing a plurality of digital luminance images. Additionally or alternatively, luminance processing the plurality of digital luminance images may comprise obtaining a plurality of digital images and converting a digital image, comprised by the plurality of digital images, to a digital luminance image The digital luminance image may be comprised by the plurality of digital luminance images. In some exemplary embodiments, processing the plurality of digital luminance images may comprise providing the digital luminance image to the luminance computer vision model. Additionally or alternatively, a result of processing the digital luminance image may be obtained from the luminance computer vision model. Additionally or alternatively, a local loss value may be calculated. The local loss value may be indicative to a difference between the result and an expected value. In some exemplary embodiments, luminance processing the plurality of digital luminance images may comprise a backpropagation. Additionally or alternatively, the backpropagation may be performed based on the local loss. Additionally or alternatively, the backpropagation may comprise updating weights associated with the luminance computer vision model. In some exemplary embodiments, a plurality of digital luminance images may be processed by the luminance computer vision model. Additionally or alternatively, a loss value may be calculated based on a plurality of local loss values. In some exemplary embodiments, in case that loss value is below a threshold the luminance computer vision model may be considered the trained luminance computer vision model.

In some exemplary embodiments, a luminance computer vision model may be based on a CNN model. Additionally or alternatively, passing a digital luminance image trough the luminance computer vision mode may comprise performing one or more luminance convolutions. Additionally or alternatively, a luminance convolution may refer to performing a convulsion with a luminance based input comprised by the digital luminance image.

In some exemplary embodiments, a luminance computer vision model may be based on a Vision Transformer (ViT) model. Additionally or alternatively, passing a digital luminance image trough the luminance computer vision mode may comprise performing one or more luminance patches. Additionally or alternatively, a luminance patch may refer to splitting the luminance based input to one or more patches. As an example, the luminance based input may be associated with a matrix of W×H values. Based on the matrix, one or more patches may be generated, each of which may be a 16×16 matrix.

In a similar manner, any architecture of a computer vision model may be utilized by the disclosed subject matter by utilizing a single virtual video channel as an input to the model or by performing a preprocessing operations on the single virtual video channel.

Yet another technical solution is to provide a digital luminance image processing algorithm by modifying a digital image processing algorithm to a digital luminance image processing algorithm. In some exemplary embodiments, the digital image processing algorithm may be configured to process an input comprising a digital image. Additionally or alternatively, the digital luminance image processing algorithm may be configured to luminance process a luminance based input comprising a digital luminance image. The digital image may be associated with a digital representation of an image. Additionally or alternatively, the digital luminance image may be associated with a digital luminance representation of the image. Additionally or alternatively, the digital representation may be associated with two or more color sets. Each color set may comprise a plurality of intensity values. Additionally or alternatively, an intensity value comprised by a color set may be indicative of an intensity of a color in a coordinate in the digital image. As an example, the digital image processing algorithm may be configured to process a color based input. The digital image may be in a BGR format. Additionally or alternatively, the digital image may comprise three color sets. A first color set comprising values representing one or more intensities of blue, a second color set comprising values representing one or more intensities of green, a third color set comprising values representing one or more intensities of red, or the like. Additionally or alternatively, the digital luminance representation of the image may be associated with a plurality of luminance values. In some exemplary embodiments, the digital luminance image processing algorithm may be configured to luminance process an input comprising a digital luminance image in a Y format. In some exemplary embodiments, the digital luminance image in the Y format may comprise the plurality of luminance values. Additionally or alternatively, the digital luminance representation may comprise a single video virtual channel, opposed to the digital color representation that may comprise tree video virtual channels. In some exemplary embodiments, modifying the digital image processing algorithm to the digital luminance image processing algorithm may comprise reducing a number of input channels associated with the digital luminance image processing algorithm.

In some exemplary embodiments, a digital image processing algorithm may be obtained. Additionally or alternatively, the digital image processing algorithm may be configured to process a digital image. Additionally or alternatively, processing the digital image may comprise performing a sub process operation two or more times, each time with an input comprising a different color set. Additionally or alternatively, modifying the digital image processing algorithm may comprise configuring the digital image processing algorithm to perform the sub process operation once, whereby the modifying operation may yield a digital luminance image processing algorithm.

In some exemplary embodiments, a digital image processing algorithm may comprise a color trained computer vision model. Additionally or alternatively, the color trained computer vision model may be configured to process a color based input comprising two or more video virtual channels, each of which may be associated with a color set. Additionally or alternatively, the color trained computer vision model may comprise weights. Additionally or alternatively, the weights may be comprised by a result of training a computer vision model. Additionally or alternatively, the weights may comprise values of one or more connections in an artificial neural network comprised by the color trained computer vision model. Additionally or alternatively, a digital luminance image processing algorithm may comprise a trained luminance computer vision model. Additionally or alternatively, the trained luminance computer vision model may be configured to luminance process an input comprising a single video virtual channel. In some exemplary embodiments, modifying the color trained computer vision model to a trained luminance computer vision model may comprise obtaining the weights and modifying the weights in order to reflect a luminance neural artificial network. In some exemplary embodiments, the neural artificial network may comprise an input layer. Additionally or alternatively, a size of the input layer may be C×W×H. Additionally or alternatively, C may denote a number of color sets. Additionally or alternatively, W may denote a width that may be associated with the digital image. Additionally or alternatively, H may denote a height that may be associated with the digital image. Additionally or alternatively, the luminance neural artificial network may comprise a luminance input layer. Additionally or alternatively, another size of the luminance input layer may be W×H. Hence, modifying the weights may comprise changing the input layer of the artificial neural network or any other layers that may be affected by changing the input layer.

In some exemplary embodiments, training a luminance computer vision model may comprise augmenting a digital luminance image by cropping the digital luminance image, rotating the digital luminance image, or the like. Additionally or alternatively, an augmented digital luminance image may be provided to the luminance computer vision model while luminance training the luminance computer vision model. In some exemplary embodiments, in case that the digital luminance image is in a YX format, augmenting the digital luminance image may comprise augmenting a Y video virtual channel, comprised by one or more video virtual channels associated with the digital luminance image. Additionally or alternatively, in case that the one or more video virtual channels comprising a zero video virtual channel, augmenting the digital luminance image may comprise augmenting the zero video virtual channel. Additionally or alternatively, augmenting the zero video virtual channel may comprise resizing the zero video virtual channel. As a result, a size of the augmented zero video virtual channel may be equal to another size of the augmented Y video virtual channel.

In some exemplary embodiments, augmenting a digital luminance image may comprise performing a Y based altering of a group of one or more luminance values comprised by the digital luminance image. In some exemplary embodiments, Y based altering may comprise altering a luminance value comprised by the group. Additionally or alternatively, the luminance value may be altered to reflect a darker digital luminance image, to reflect a brighter digital luminance image, or the like. In some exemplary embodiments, a portion of the digital luminance image may be Y based altered. The portion may correspond to one or more bounding boxes, each of which may define an area comprising an object displayed in the image. Additionally or alternatively, Y based altering the digital luminance image may comprise darkening an area defined by a bounding box, brightening an area defined by the bounding box, or the like.

Yet another technical solution is to perform a sub processing operation once in order to process a digital image. The digital color image processing algorithm may be a digital color image filter, a trained color computer vision model, or the like. Additionally or alternatively, the digital color image processing algorithm may be configured to process a color based input. Additionally or alternatively, the digital color processing algorithm may be configured to train a color computer vision model. Additionally or alternatively, the digital color processing algorithm may be configured to encode a digital color image. In some exemplary embodiments, a digital color processing algorithm may be configured to execute the sub processing operation two or more two or more times. In each execution a different color virtual channel may be provided as an input to the sub processing operation. As an example, the digital color image processing algorithm may be configured to color process a digital color image in RGB format. Additionally or alternatively, color processing the digital color image may comprise executing the sub processing operation three times. A first execution with an input comprising a red video virtual channel, wherein the red video virtual channel may comprise one or more values, each of which may indicate an intensity of red in a coordinate in the digital image. A second execution with an input comprising a green video virtual channel, wherein the green video virtual channel may comprise one or more values, each of which may indicate an intensity of green in a coordinate in the digital image. A third execution with an input comprising a blue video virtual channel, wherein the blue video virtual channel may comprise one or more values, each of which may indicate an intensity of blue in a coordinate in the digital image. In some exemplary embodiments, based on the digital image, a digital luminance image may be obtained. Additionally or alternatively, the digital luminance image may be luminance processed. Additionally or alternatively, luminance processing the digital luminance image may comprise performing executing the sub processing operation once with an input comprising a Y video virtual channel, wherein the Y video virtual channel is comprised by the digital luminance image.

Yet another technical solution is to increase a batch size. In some exemplary embodiments, a computerized apparatus may be configured to train a computer vision model based on a dataset. The batch size may be indicative to a number of data items that may be stored in a RAM of the computerized apparatus. In some exemplary embodiments, a luminance computer vision model may be trained based on the dataset. The dataset may comprise a Y group, may comprise one or more digital luminance images, or the like. Additionally or alternatively, training the luminance computer vision model may comprise determining the larger batch size. The larger batch size may be determined based on a size of one or more data items comprised by the dataset. In some exemplary embodiments, a first batch size may be 16, 32, 64, or the like. Additionally or alternatively, a second batch size may be 128, 256, 512, 1024, 2048, 4096, or the like. It may be desired to determine the batch size to the second size. In some exemplary embodiments, the larger batch size may be bounded above by an available RAM size. By utilizing the disclosed subject matter the batch size may be set to the second size. As an example, an average digital luminance image may be 640×480. Additionally or alternatively, eight bits may be required to retain one luminance value. Hence, 640×480×8 bits may be required to retain the digital luminance image.

One technical effect of utilizing the disclosed subject matter is an efficient processing of a digital image. In some exemplary embodiments, a computerized apparatus may be configured to utilize the disclosed subject matter. The computerized apparatus may process the digital image more efficiently compared to another computerized apparatus. The other computerized apparatus may be similar to the computerized apparatus. Additionally or alternatively, the computerized apparatus may comprise hardware. Additionally or alternatively, the other computerized apparatus may comprise another hardware. Additionally or alternatively, the hardware and the other hardware may have an identical specifications.

Yet Another technical effect of utilizing the disclosed subject matter is a reduced complexity of a modified digital image processing algorithm compared to a digital image processing algorithm. In some exemplary embodiments, the modified digital image processing algorithm may be a digital luminance image processing algorithm. Additionally or alternatively, the digital image processing algorithm may be modified to the digital luminance image processing algorithm. In some exemplary embodiments, a digital luminance image may be associated with a single video virtual channel. The single video virtual channel may be a Y video virtual channel. Additionally or alternatively, the digital luminance image may be associated with a digital luminance representation of an image. The image may be associated with a width W and with a height H. A first cardinality of the Y video virtual channel may be a first product. The first product may be a product of W and H (i.e. W×H). Put differently, the Y video virtual channel may be associated with W×H luminance values. In some exemplary embodiments, a digital image may be associated with another digital representation of the image. In case that the other digital representation is a digital color representation in RGB format, in BGR format, or the like, the digital image may comprise three video virtual channels. A second cardinality of the three video virtual channels may be the product of 3, W, and H (i.e. 3×W×H). Hence, a complexity of the digital image processing algorithm may be associated with a constant factor of at least three while another complexity of the digital luminance image processing algorithm may be associated with another constant factor. The other constant factor may be equal to the constant factor divided by three.

As an example, a digital image processing algorithm may be configured to process an input comprising a tensor having dimensions of C×W×H. In some exemplary embodiments, C may denote a number of color matrices, W may denote a width of an image in pixels, H may denote a height of the image in pixels. In some exemplary embodiments, a modified digital image processing algorithm may be configured to luminance process an input comprising another tensor having the dimensions 1×W×H, W×H, or the like.

As another example, the digital image processing algorithm may be configured to process an input comprising three vectors. A first vector may comprise red values, a second vector may comprise green values, a third vector may comprise blue values, or the like. It may be noted that in this example, the vectors are considered as an unordered set, yielding their order is irrelevant. In some exemplary embodiments, the modified digital image processing algorithm or the digital luminance image processing algorithm may be configured to luminance process an input comprising a single vector. The single vector may comprise a plurality of luminance values.

As yet another example, a digital image processing algorithm may be configured to process an input comprising a single vector. Each entry in the single vector may comprise a number of values. The number of values may be equal to C. In some exemplary embodiments, C may denote a number of color vectors utilized in order to digitally represent the image. Additionally or alternatively, each color may be represented by a value in each entry. Additionally or alternatively, a digital luminance image processing algorithm may be configured to luminance process an input comprising another single vector. An entry comprised by the other single vector may comprise a single luminance value. Hence, the other single vector may be C times smaller than the single vector.

Yet Another technical effect of utilizing the disclosed subject matter is a reduction of a time needed to process one or more digital images based on one or more digital luminance images compared to processing one or more digital images based on one or more non luminance digital images. In some exemplary embodiments, a computerized apparatus may be configured to perform a luminance task. Additionally or alternatively, performing the luminance task may require a first duration. The first duration may be three milliseconds, twenty seconds, thirty minutes, an hour, four days, one months, or the like. Additionally or alternatively, the computerized apparatus may be configured to perform a task. The task and the luminance task may be a same task. Additionally or alternatively, a second duration may be required for the computerized apparatus to perform the task. The second duration may be larger than the first duration. In some exemplary embodiments, a luminance task may comprise luminance processing an image based on a digital luminance image representing the image. Additionally or alternatively, the task may comprise processing the image based on a digital image representing the image. As an example, the luminance task may be to luminance analyze the image, to luminance filter the image, or the like, based on the digital luminance image. Additionally or alternatively, the task may be to analyze the image, to filter the image, or the like, based on the digital image. Additionally or alternatively, the computerized apparatus may perform the luminance task in ten milliseconds. Additionally or alternatively, the computerized apparatus may perform the task in twelve milliseconds, in fifteen milliseconds, or the like.

As another example, a luminance task may comprise luminance training a luminance computer vision model based on a luminance dataset. In some exemplary embodiments, a luminance dataset may comprise a plurality of digital luminance images. Additionally or alternatively, a task may be to train a computer vision model based on a dataset. The dataset may comprise a plurality of digital image. In some exemplary embodiments, a number of items in the dataset may be equal to another number of items in the luminance dataset. In some exemplary embodiments, the computerized apparatus may complete training the luminance computer vision model in a first duration while completing training the computer vision model may require a second duration. In some exemplary embodiments the first duration may be 24 hours, 2 days, 200 hours, or the like. Additionally or alternatively, the second duration may be larger than the first duration in 10%, in 17 percent, or the like.

Yet another technical effect of utilizing the disclosed subject matter is to obtain a digital image in a ready format in order to process the digital image.

Yet another technical effect of the utilizing disclosed subject matter is a reduction in computational resources that may be required for luminance processing a Y group or a group comprising one or more digital luminance images compared to another computational resources that may be required for processing another group comprising one or more digital images. In some exemplary embodiments, the computational resources may comprise one or more CPUs, one or more GPUs, an amount of RAM, or the like. In some exemplary embodiments, the amount of RAM that may be required for retaining a portion of the group or a portion of the Y group while it is being luminance processed may be three times less compared to processing a portion of the other group. As a result, less CPU cycles may be required for luminance processing, less GPU operations may be required for luminance processing, or the like. In some exemplary embodiments, luminance processing the group or the Y group may result in a trained luminance computer vision model.

In some exemplary embodiments, a reduction in computational resources may be achieved by utilizing the disclosed subject matter in order to train a luminance computer vision model. In some exemplary embodiments, a digital luminance image processing algorithm may be configured to luminance train the luminance computer vision model. The digital luminance image processing algorithm may be configured to retain in a RAM a plurality of digital luminance images. Additionally or alternatively, the digital luminance image processing algorithm may be associated with a batch size. The batch size may be indicative to a size in bytes of a plurality of digital images that may be comprised by a batch. Additionally or alternatively, the batch size may be above bounded by an available RAM size. Put differently, the smaller an average size of the images the larger another batch size may be. Additionally or alternatively, it may be desired that the RAM may be able to retain as much data samples as possible. Hence, by utilizing the disclosed subject matter it may be possible to retain in the RAM three times more digital luminance images compared to holding in the RAM another plurality of digital images.

Yet another technical effect of utilizing the disclosed subject matter is a larger batch size compared to not utilizing the disclosed subject matter. In some exemplary embodiments, the disclosed subject matter may be utilized in order to luminance train a luminance computer vision model. In those embodiments, the larger batch size may be utilized.

Yet another technical effect of utilizing the disclosed subject matter is an improved user experience. In some exemplary embodiments, an application may be configured to process one or more images. Additionally or alternatively, the application may be installed on a computerized device. Additionally or alternatively, the application may be configured to display one or more processed images to a user. By utilizing the disclosed subject matter, processing one or more images may be based on one or more digital luminance images. Additionally or alternatively, as such processing may be based on a single Y video virtual channel per image, such processing may be faster, compared to another processing which may be based on two or more video virtual channels. As a result, the application may respond faster to a user request compared to another application not utilizing the disclosed subject matter. The other application may be configured to perform a same task as the application. As an example, the application may be configured to allow the user to click an area on the screen. In response to a user click, the application may be configured to identify an object displayed in the area. By utilizing the disclosed subject matter, responding to a user click may be completed faster compared to utilizing the other application on the computerized device.

Yet another technical effect of utilizing the disclosed subject matter is eliminating a conversion from a digital image in a YUV format to another digital image in a BGR format, in a RGB format, or the like, in order to process the image based on the other digital image.

In some exemplary embodiments, a reduction in computational resources may be achieved by providing a digital image processing algorithm with a digital luminance image as an input. Additionally or alternatively, the digital luminance image may comprise a plurality of dummy values. The digital luminance image may be in a Y00, in a YYY format or the like. In that case, utilizing the computerized apparatus for processing an image may yield a reduction in computational resources required by the computerized apparatus to process the image compared to another computerized apparatus not configured to utilize the disclosed subject matter. In some exemplary embodiments, in case that the digital luminance image is in Y00 format, Y000 format, or the like, performing an arithmetic operation on an input comprising zero values may be faster than performing the arithmetic operation on an input comprising non zeros values. In some exemplary embodiments, a computerized apparatus configured to process the digital luminance image may be configured to repeat a sub processing operation. Additionally or alternatively, the sub processing operation may be repeated for each video virtual channel comprised by the digital luminance image. As an example, the digital luminance image may be of a Y00 format. Additionally or alternatively, the sub processing operation may be a convolution. Additionally or alternatively, the computerized apparatus may be configured to repeat the convolution three times. A first time with an input comprising a Y video virtual channel. Additionally or alternatively, the computerized apparatus may be configured to perform the sub processing operation, the convolution, twice with an input comprising a zero video virtual channel.

In some exemplary embodiments, in case that the digital luminance image is in Y00 format, Y000 format, or the like, the computerized apparatus may be configured to avoid multiplication of a vector consisting of zeros. Additionally or alternatively, in case that the digital luminance image is in YYY format, in YYYY format, or the like, the computerized apparatus may be configured to reuse a result of another multiplication of a Y vector comprising the plurality of luminance and a scalar, a vector, a matrix, or the like, comprised by a processing operation, comprised by a digital luminance image processing algorithm, or the like.

Yet another technical effect of utilizing the disclosed subject matter is a reduction of a memory needed to retain an input while utilizing a luminance image processing algorithm compared to utilizing a digital image processing algorithm. In some exemplary embodiments, a digital image may be associated with a width W and with a height H. Additionally or alternatively, in case that the digital image comprises C color sets, a cardinality of the C color sets may be C×W×H. Additionally or alternatively, a luminance cardinality may be another cardinality of a plurality of luminance values. In that case, the luminance cardinality may be W×H. As the digital image processing algorithm is configured to process an input comprising the color sets, and as the digital luminance image processing algorithm is configured to process an input comprising the plurality of luminance values, a memory needed for retaining the input of the digital luminance image processing algorithm may be C times smaller than another amount of memory needed to retain an input of the digital image processing algorithm.

Yet another technical effect of utilizing the disclosed subject matter is a reduced computerized resources that may be required by an application configured to process an image based on a digital luminance image compared to another application configured to process the image based on a digital image comprising one or more pluralities of color values. In some exemplary embodiments, a YUV digital image may be obtained from a light sensor, from a file, from a socket, or the like. Additionally or alternatively, the YUV digital image may be in a YUV format, in a Y′UV format, or the like. Additionally or alternatively, obtaining the YUV digital image may comprise obtaining a plurality of luminance values. Additionally or alternatively, obtaining the YUV digital image may comprise obtaining one or more pluralities of chrominance values. Additionally or alternatively, the one or more pluralities of chrominance values may be a result of obtaining one or more volatile chrominance values and subsampling a volatile chrominance values comprised by the one or more pluralities of chrominance values. As a result, the YUV digital image may comprise 2×W×H, 1.5×W×H, or the like, intensity values while the digital image may comprise C×W×H intensity values. Additionally or alternatively, the Y or the Y′ video virtual channel may be processed, thus eliminating a conversation from the YUV digital image to the digital image. The digital image may be in a RGB format, BGR format, or the like. It may be noted that converting the YUV digital image to the digital image may be an expensive operation in terms of computerized resources. In some exemplary embodiments, the application may be configured to further process the YUV digital image, such as by encoding the YUV digital image, utilizing another luminance computer vision model, or the like. In that case, a second conversation from an output of a digital image processing algorithm to a YUV format may also be eliminated.

In some exemplary embodiments, processing a digital image may comprise processing each video virtual channel. As an example, in case that the digital image comprises an RGB representation of the image, processing the digital image may comprise processing a red video virtual channel, processing a green video virtual channel, processing a blue video virtual channel, or the like. Additionally or alternatively, processing a digital luminance image may comprise processing each video virtual channel. However, processing a zero virtual channel may be much faster compared to processing a non zero plurality of values as multiplying a zero vector with another vector may be zero. Additionally or alternatively, a computerized apparatus may be configured to detect that an input to such multiplication comprises a zero vector and to return zero without executing the multiplication. Additionally or alternatively, in case the digital luminance image may be in a YY format, in a YYY format, or the like, the computerized apparatus may be configured to cache a result of multiplying the first Y video virtual channel with another vector and to reuse the result. Additionally or alternatively, the digital luminance image may be in a Y format. In those cases the digital luminance image may comprise a single video virtual channel. Additionally or alternatively, the computerized apparatus may be configured to process the single video virtual channel.

Yet another technical effect of utilizing the disclosed subject matter is to process a digital image by executing a single sub processing operation, whereby reducing a number of floats operations (FLOPS) by a factor of C, wherein C may denote a number of video virtual channels associated with the digital image.

Yet another technical effect of utilizing the disclosed subject matter is to luminance process a digital luminance image instead of processing a digital image.

The disclosed subject matter may provide for one or more technical improvements over any pre existing techniques and any techniques that have previously become routine or conventional in the art. Additional technical problems, solutions and effects may be apparent to a person of ordinary skill in the art in view of the present disclosure.

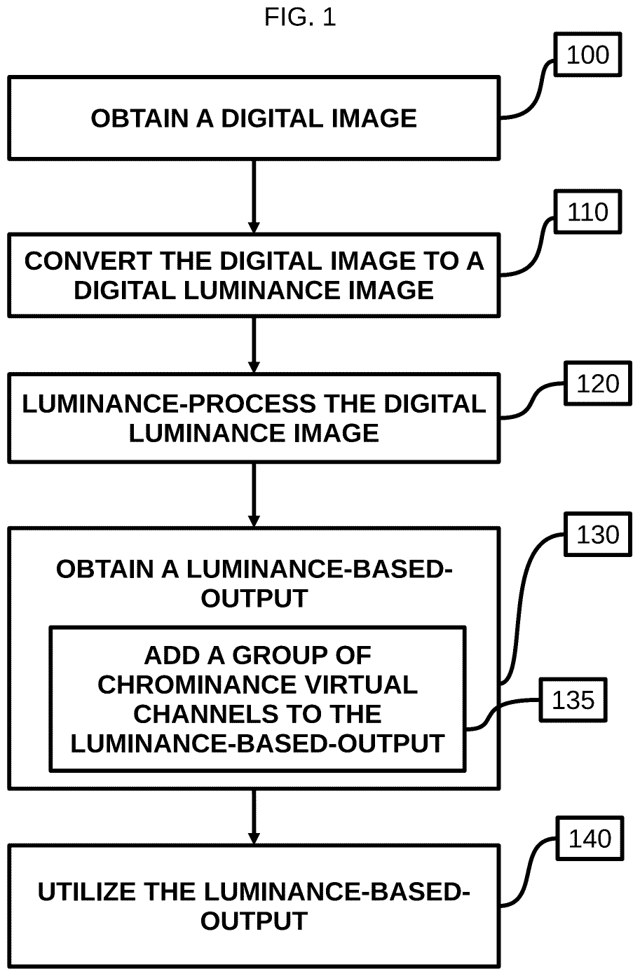

Referring now to FIG. 1 showing a flowchart diagram of a method, in accordance with some exemplary embodiments of the disclosed subject matter.

On Step 100, a digital image may be obtained. The digital image may be obtained by utilizing a light sensor, such as a camera, or the like. Additionally or alternatively, the digital image may be obtained by reading a portion of a file from a local medium, from a remote server, from a remote computerized apparatus, or the like. In some exemplary embodiments, the digital image may be obtained in an encoded form, may be comprised by a video stream, or the like. In some exemplary embodiments, the digital image may be associated with a digital representation of an image.

On Step 110, the digital image may be converted to a digital luminance image. In some exemplary embodiments, the digital luminance image may be associated with a plurality of luminance values. A luminance value comprised by the plurality of luminance values may be indicative of a luminance intensity in one or more coordinates in the digital image, in the digital luminance image, or the like. In some exemplary embodiments, the digital image may be a Y digital image. In some exemplary embodiments, a Y digital image may be a digital image in any YUV format. In those embodiments, converting the Y digital image to a digital luminance image may comprise associating a Y portion of the digital image with the digital luminance image. Additionally or alternatively, in case that a copy operation is required from the digital image to the digital luminance image, the copy operation may copy the Y portion of the digital image.

In some exemplary embodiments, a digital luminance image may be associated with one or more video virtual channels. At least one video virtual channel associated with the digital luminance image may be a Y video virtual channel. Additionally or alternatively, the Y video virtual channel may be associated with the plurality of luminance values. Additionally or alternatively, the Y video virtual channel may be a vector, a matrix, or the like, comprising the plurality of luminance values.

In some exemplary embodiments, a digital luminance image may be associated with a plurality of dummy values. Additionally or alternatively, a portion of the plurality of dummy values may be associated with another Y video virtual channel. The other Y video virtual channel may be associated with the plurality of luminance values. In some exemplary embodiments, the other Y video virtual channel may be a vector comprising the plurality of luminance values. Additionally or alternatively, the other Y video virtual channel may be another vector comprising copies of the plurality of luminance values.

In some exemplary embodiments, a portion of a plurality of dummy values may comprise a plurality of zeros. The plurality of zeros may be associated with one or more zero virtual channels. In some exemplary embodiments, a zero virtual channel and a Y video virtual channel may be associated with a same number of values. Additionally or alternatively, the same number may be equal to a product of a width of an image and a height of the image, wherein the digital luminance image may be associated with a digital luminance representation of the image. Put differently, the digital luminance image may represent the image based on the Y video virtual channel.

In some exemplary embodiments, a digital luminance image may be associated with one or more Y video virtual channels. Additionally or alternatively, the digital luminance image may be associated with one or more zero video virtual channels.

In some exemplary embodiments, a digital luminance image may be in a Y format. Additionally or alternatively, the digital luminance image may comprise a single video virtual channel. Additionally or alternatively, the single video virtual channel may be a Y video virtual channel. Additionally or alternatively, the Y video virtual channel comprised by the digital luminance image, may be associated with a plurality of luminance values. In some exemplary embodiments, the single video virtual channel may be referred to as a Y group. Additionally or alternatively, the single video virtual channel may be comprised by the Y group. The Y group may comprise another single video virtual channel. The other single video virtual channel may represent another image.

In some exemplary embodiments, a digital luminance image may be in a YX format. X may denote one or more dummy video virtual channels. Additionally or alternatively, the digital luminance image may be associated with a Y video virtual channel. Additionally or alternatively, a second video virtual channel may be associated with the digital luminance image. In some exemplary embodiments, in case that the second video virtual channel is associated with a plurality of zeros, the digital luminance image may be in a Y0 format. Additionally or alternatively, in case that the second video virtual channel is associated with the plurality of luminance values, the digital luminance image may be in a YY format. In some exemplary embodiments, the digital luminance image may be associated with a third video virtual channel. Additionally or alternatively, in case that the third video virtual channel is associated with the plurality of luminance values, the digital luminance image may be in a YYY format, Y0Y format, or the like. In some exemplary embodiments, the digital luminance image of the YX format may comprise a Y video virtual channel followed by any combination of Y video virtual channels and zero virtual channels.

In some exemplary embodiments, a YX format may be equivalent to a XY format. Put differently, a digital luminance image may comprise a group of one or more video-virtual-channels. A first luminance based output of a digital luminance processing algorithm may be based on a first luminance based input in a YX format. Additionally or alternatively, a second luminance based output of the digital luminance processing algorithm may be based on a second luminance based input in a YX format. Additionally or alternatively, a difference between the first luminance based output and the second luminance based out put may be below a threshold.

In some exemplary embodiments, a digital luminance image may be associated with a single video virtual channel. The single video virtual channel may be a Y video virtual channel. Additionally or alternatively, the digital luminance image may be in a YX format, yielding that X may be an empty set.

In some exemplary embodiments, a digital image may be a Y digital image. The Y digital image may be in a YUV format, in a Y′UV format, in a YCbCr format, or the like. In those embodiments, converting the digital image to the digital luminance image may comprise removing the plurality of chrominance values from the digital image. Additionally or alternatively, converting the digital image to the digital luminance image may comprise associating the digital luminance image with another Y video virtual channel associated with the Y digital image, such as by providing a pointer pointing to the luminance portion of the Y digital image.

In some exemplary embodiments, a digital image may be associated with an intensity set. Additionally or alternatively, an intensity value comprised by the intensity set may be indicative of an intensity of a visual quality in one or more coordinates in the digital image. The intensity of the visual quality may be a luminance intensity, a red intensity, a hue intensity, a green intensity, or the like. Additionally or alternatively, the intensity of the visual quality may be an intensity of a chrominance. In some exemplary embodiments, the intensity set may comprise a luminance set. Additionally or alternatively, the intensity set may comprise one or more chrominance sets. In some exemplary embodiments, the luminance set may be represented as a luminance vector. The luminance vector may be a vector comprising luminance values as elements. Additionally or alternatively, a chrominance set may be represented by a chrominance vector. The chrominance vector may be a vector comprising chrominance values as elements. Additionally or alternatively, the intensity set may comprise a plurality of luminance values. Additionally or alternatively, the intensity set may comprise a plurality of color values. As an example, the digital image may represent an image. In case that the digital representation is in RGB format, BGR format, or the like, the intensity set may comprise three color sets, three pluralities of color values, or the like. A first set may comprise a first plurality of color values. A color value comprised by the first plurality may be indicative of a red intensity of the Red color in a coordinate in the image. Similarly, a second intensity set may comprise a second plurality of color values associated with the color Green. Similarly, a third intensity set may comprise a third plurality of color values associated with the color Blue.

In some exemplary embodiments, an intensity set may comprise one or more color sets. A color set may be associated with a representation of a color. Additionally or alternatively, the color set may comprise a color value. The color value may be indicative of an intensity of a color in a coordinate in a digital image. The color may be red, green, blue, magenta, orange, or the like. In some exemplary embodiments, a color set may be represented by a color vector. Additionally or alternatively, the digital image may be associated with one or more color vectors, such as a color vector comprising one or more red values of one or more pixels; a color vector comprising green values of one or more pixels; a color vector comprising blue values of one or more pixels; or the like. Additionally or alternatively, a pixel comprised by the one or more pixels may be comprised by the digital image. In some exemplary embodiments the digital image may be of an RGB format, an RGBA format, a BGR format, or the like.

In some exemplary embodiments, a digital image may be associated with an intensity set associated with a plurality of luminance values and two pluralities of chrominance values. In those cases, the digital image may be a Y digital image.

In some exemplary embodiments, a digital luminance image may be associated with an intensity set. Additionally or alternatively, the intensity set may be associated with a plurality of luminance values. In those cases, the digital luminance image may be in a YX format.

In some exemplary embodiments, a plurality of luminance values may be obtained based on a digital image. In some exemplary embodiments, the plurality of luminance values be defined by a set of luminance values. In some exemplary embodiments, in case that the digital image is a Y digital image, the luminance set may be copied to a buffer. Additionally or alternatively a pointer pointing to the luminance set in the digital image may be allocated for representing the plurality of luminance values. In some exemplary embodiments, in case that the digital image is in RGB format, obtaining the luminance set may comprise utilizing a formula such as Y=0.299×R+0.587×G+0.114×B. In some exemplary embodiments, R may denote a first color vector of red values associated with the digital image. Additionally or alternatively, G may denote a second color vector of green values associated with the digital image. Additionally or alternatively, B may denote a third color vector of blue values associated with the digital image. It may be noted that other formulas may be utilized in order to obtain a similar luminance set from another digital image. The other digital image may comprise a color set comprising values other than red or green or blue values.

On Step 120, a digital luminance image may be luminance processed. In some exemplary embodiments, luminance processing the digital luminance image may comprise providing the digital luminance image, as an input, to a digital luminance image processing algorithm. Additionally or alternatively, processing the digital luminance image may comprise sub processing a video virtual channel associated with the digital luminance image. Additionally or alternatively, the digital luminance image processing algorithm may be configured to luminance process the digital luminance image and to provide a luminance based output.

In some exemplary embodiments, luminance processing a digital luminance image may comprise invoking a digital luminance image processing algorithm, executing the digital luminance image processing algorithm, or the like. Additionally or alternatively, the digital luminance image processing algorithm may be configured to process an input comprising the digital luminance image, associated with the digital luminance image, or the like.

In some exemplary embodiments, a digital luminance image processing algorithm may comprise a single input channel. In that case, the digital luminance image may be of a Y format. Additionally or alternatively, the single input channel may be associated with a plurality of luminance values. Additionally or alternatively, the single video virtual channel may be a Y video virtual channel.

In some exemplary embodiments, invoking the digital luminance image processing algorithm may yield a plurality of processed luminance values. Additionally or alternatively, a luminance based output may be an output of the digital luminance image processing algorithm. Additionally or alternatively, the luminance based output may be associated with the plurality of processed luminance values.

In some exemplary embodiments, invoking a digital luminance image processing algorithm may comprise analyzing an image, wherein the image may be represented by a digital luminance image. Additionally or alternatively, analyzing the image may be based on luminance analyzing the digital luminance image. Additionally or alternatively, analyzing the image may yield an information regarding the image. Additionally or alternatively, the information may comprise a representation of one or more coordinates, each of which may be indicative to a coordinate of an object displayed in the image. Additionally or alternatively, a coordinate may be indicative to a facial landmark of a face displayed in the image. Additionally or alternatively, analyzing the image may yield one or more segments comprised by the image, a list of people displayed in the image, a text displayed in the image, a classification of objects displayed in the image, a compressed version of the image, a restored version of the image, a newly generated image based, or the like.

In some exemplary embodiments, the luminance based output may comprise the plurality of processed luminance values. In those embodiments, the luminance based output may be displayed to a user as a digital image. In some exemplary embodiments, the digital luminance image processing algorithm may be configured to blur the image, to improve the quality of the image, to digitally filter the image, or the like. Additionally or alternatively, the digital luminance image processing algorithm may be a trained luminance computer vision algorithm configured to analyze the image. In some exemplary embodiments, analyzing the image may comprise detecting one or more objects displayed in the image, tracking one or more objects displayed in one or more images, providing a live avatar of an object that may be displayed in the one or more images, or the like. Additionally or alternatively, processing the image may comprise performing one or more matrix operations such as matrix multiplication or convolution. Additionally or alternatively, a matrix operation may be based on an input comprising a portion of the digital luminance representation. Additionally or alternatively, digitally filtering an image may comprise performing one or more matrix operations such as matrix multiplication or convolution.

In some exemplary embodiments, luminance processing a digital luminance image may comprise performing one or more sub processing operations. Additionally or alternatively, a sub processing operation may be performed based on an input comprising a video virtual channel associated with the digital luminance image. Additionally or alternatively, a sub processing operation may comprise a matrix multiplication operation. Additionally or alternatively, the sub processing operation may comprise invoking a digital luminance filter with an input comprising the video virtual channel. Additionally or alternatively, luminance processing the digital luminance image may comprise performing the sub processing operation with another video virtual channel associated with the digital luminance image.

In some exemplary embodiments, a digital image processing algorithm may be modified to a digital luminance image processing algorithm. In some exemplary embodiments, modifying the digital image processing algorithm to the digital luminance image processing algorithm may comprise removing at least a sub processing operation, resulting in the digital luminance image processing algorithm. The sub processing operation may be comprised by one or more sub processing operations. Additionally or alternatively, invoking the digital image processing algorithm may comprise performing the one or more sub processing operations. Additionally or alternatively, the digital luminance image processing algorithm may comprise a single sub processing operation. In some exemplary embodiments, modifying the digital image processing algorithm to the digital luminance image processing algorithm may comprise reducing a number of input channels. Additionally or alternatively, the digital image processing algorithm may be configured to process an input comprising the digital image. In some exemplary embodiments, the digital image may be associated with a representation of the image. The representation may comprise two or more video virtual channels. Additionally or alternatively, the digital luminance image processing algorithm may be configured to luminance process, as an input, the digital luminance image. Additionally or alternatively, the digital luminance image may be associated with a single channel, a Y video virtual channel, comprising a plurality of luminance values.

In some exemplary embodiments, a digital image processing algorithm may comprise a convolution. Additionally or alternatively, modifying the digital image processing algorithm may comprise reducing a number of dimensions of a kernel of the convolution. In some cases, the kernel may be changed from a C dimension matrix to single dimension matrix, to a vector, to a one dimensional matrix, or the like. Additionally or alternatively, the digital luminance image processing algorithm may comprise the changed kernel.

In some exemplary embodiments, a digital luminance image processing algorithm may be a modified digital image processing algorithm. Additionally or alternatively, invoking the digital luminance image processing algorithm may yield a luminance based output. Additionally or alternatively, invoking the digital image processing algorithm may yield an output. Additionally or alternatively, a difference between the luminance based output and the output may be below a threshold.

In some exemplary embodiments, a digital image processing algorithm may comprise one or more multiplication operations. A multiplication operation may comprise multiplying a portion of an input of the digital image processing algorithm and a kernel data structure. The kernel data structure may be a matrix, a vector, or the like. The portion of the input of the digital image processing algorithm may comprise another matrix, another tensor, another vector, or the like. In some exemplary embodiments, the portion of the input may comprise one or more color sets. Additionally or alternatively, the portion of the input may be comprised by a vector representing a color set, such as a first vector comprising red values, a second vector comprising blue values, a third vector comprising green values, or the like.

In some exemplary embodiments, a digital luminance image processing algorithm may comprise one or more multiplication operations. A multiplication operation may comprise multiplying a portion of an input of the digital luminance image processing algorithm and a kernel data structure. The kernel data structure may be a matrix, a vector, a tensor, or the like. The portion of the input of the digital luminance image processing algorithm may comprise another matrix, another tensor, another vector, or the like. In some exemplary embodiments, the portion of the input may be comprised by a plurality of luminance values. Additionally or alternatively, the plurality of luminance values may be comprised by another vector, by another matrix, by another tensor, or the like.

In some exemplary embodiments, modifying a digital image processing algorithm may comprise modifying a kernel data structure. Modifying the kernel data structure may comprise reducing the number of dimensions of the kernel data structure in order to allow a multiplication of a single Y video virtual channel and the changed kernel data structure. The single Y video virtual channel may be associated with a digital luminance image. Additionally or alternatively, the single Y video virtual channel may be represented by a matrix, by a tensor, by a vector, or the like. As an example, the digital image may comprise a digital representation of the image in a BGRM (Blue, Green, Red, Magenta) format. In that case, an intensity set may comprise four color sets. Additionally or alternatively, the kernel data structure may be represented as a tensor. Additionally or alternatively, the tensor may be associated with dimensions such as 4×W×H, wherein W and H may denote a width and a height of an image, wherein the digital image and digital luminance image may represent the image. Additionally or alternatively, a modified kernel data structure may be represented by a modified tensor. Additionally or alternatively, the modified tensor may be associated with another dimensions such as W×H, 1×W×H, or the like.

In some exemplary embodiments, a digital image processing algorithm may be configured to perform a task. The task may be to digitally filter a digital representation of the image, to analyze the digital representation of the image, or the like. Additionally or alternatively, a digital luminance image processing algorithm may be configured to perform a luminance task. The luminance task may be to digitally luminance filter a digital luminance representation of the image, to luminance analyze the digital luminance representation of the image, or the like. In some exemplary embodiments, the digital image processing algorithm may be configured to output an output. Additionally or alternatively the digital luminance image processing algorithm may be configured to output a luminance based output. Additionally or alternatively, a difference between the output and the luminance based output may be below a threshold, yielding that the task and the luminance task are a same task. As an example, the task may be to output a blurred version of the image. The digital image processing algorithm may be configured to process an input comprising the digital image and to output the output. Additionally or alternatively, the output may comprise a blurred version of the image. Additionally or alternatively, the digital luminance image processing algorithm may be configured to luminance process another input comprising a digital luminance image and to output another blurred version of the image. In some exemplary embodiments, a difference between the blurred version and the other blurred version may be below the threshold.

As another example, a digital luminance image processing algorithm may be configured to analyze an image based on a digital luminance image representing the image. Additionally or alternatively, a digital image processing algorithm may be configured to analyze the image based on a digital image representing the image. Additionally or alternatively, a luminance based output may be an output of the digital luminance image processing algorithm. Additionally or alternatively, the luminance based output may comprise a set of coordinates in the image, may comprise a set of landmarks of a face displayed in the images, or the like. Additionally or alternatively, an output of the digital image processing algorithm may comprise another set of coordinates in the image, may comprise another set of landmarks of the face displayed in the images, or the like. In some exemplary embodiments, a difference between the set of coordinates and the other set of coordinates may be below a threshold. A difference between the set of coordinates and the other set of coordinates may be below a threshold. Additionally or alternatively, another difference between the set of landmarks and the other set of landmarks may be below the threshold. Additionally or alternatively, the digital luminance image processing algorithm may be associated with a luminance accuracy. In some exemplary embodiments, the luminance accuracy may be indicative of a success rate of the digital luminance image processing algorithm. Similarly, the digital image processing algorithm may be associated with an accuracy. The accuracy may be indicative of another success rate of the digital image processing algorithm. Additionally or alternatively, yet another difference between the accuracy and the luminance accuracy may be below another threshold.

In some exemplary embodiments, a digital luminance image may comprise a Y video virtual channel. The Y video virtual channel may be associated with a plurality of luminance values. Additionally or alternatively, in the disclosed subject matter, the Y′ virtual channel may be referred to as the Y video virtual channel associated with another plurality of luminance values that may be calculated based on a gamma corrected RGB values. Additionally or alternatively, in the disclosed subject matter, a Y′UV format may be referred to as a YUV format.

In some exemplary embodiments, in order to avoid modifying the digital image processing algorithm, two or more video virtual channels may be associated with the digital luminance image. The digital luminance image may be associated with a single Y video virtual channel, a Y video virtual channel. A dummy video virtual channel may be associated with the digital. The dummy video virtual channel may be a copy of the Y video virtual channel. Additionally or alternatively, the dummy video virtual channel may be a zero virtual channel. The zero virtual channel may be associated with a plurality of values, each of which may be equal to zero. In some exemplary embodiments, a number of zero values associated with the zero virtual channel may be equal to another number of the plurality of luminance values. In some exemplary embodiments, a format of a digital luminance image may be marked based on the one or more video virtual channels associated thereby. As an example, in case that the digital luminance image comprises a single video virtual channel associated with the plurality of luminance values, the digital luminance image may be of a Y format. Additionally or alternatively, in case that the digital luminance image associated with three video virtual channels, each of which associated with the plurality of luminance values, the digital luminance image may be of a YYY format. Additionally or alternatively, in case that the digital luminance image comprises the Y video virtual channel and two zero virtual channels, the digital luminance image may be of a Y00 format, of a 0Y0 format, of a 00Y format, or the like. In some exemplary embodiments, in case that the digital luminance image comprises at least one Y video virtual channel, the digital luminance image may be of a YX format. In that case, the X may denote a set of video virtual channels selected from a group comprising a Y video virtual channel, zero virtual channel, an empty set, or the like. As a result, an input comprising the digital luminance image may be provided to the digital image processing algorithm, whereby utilizing a portion of the disclosed subject matter without modifying the digital image processing algorithm.

In some exemplary embodiments, a digital luminance image may comprise a set of luminance values and one or more dummy sets. A dummy set comprised by the one or more dummy sets may be a zero set. Additionally or alternatively, another dummy set comprised by the one or more dummy sets may be a copy of a Y video virtual channel comprised by the digital luminance image. Additionally or alternatively, a zero value comprised by the zero set may be zero. In some exemplary embodiments, the digital luminance image comprising the luminance set and two or more zero sets may be of in a Y00 format, in a Y000 format, or the like. In some exemplary embodiments, the zero set may consist of one or more zeros. Additionally or alternatively, a cardinality of the zero set may be equal to another cardinality of the luminance set. In some exemplary embodiments, the digital luminance image in the Y00 format, in a YYY format, in a Y0Y0 format, or the like, may be provided, as an input, to a digital luminance image processing algorithm. Additionally or alternatively, the digital luminance image processing algorithm may be identical to a digital image processing algorithm. As an example, a trained computer vision model may be obtained. The trained computer vision model may comprise weights ready to be utilized in order to process a digital image. The pretrained computer vision model may be configured to process an input comprising one or more video virtual channels. A video virtual channel comprised by the input may be associated with a plurality of color values. As an example, a first video virtual channel may be associated with a plurality of red values, a second video virtual channel may be associated with a plurality of green values, or the like. Nevertheless, in some exemplary embodiments, the digital luminance image may be provided as an input to the pretrained computer vision algorithm. Additionally or alternatively, a red cardinality may be a cardinality of the plurality of red values. The red cardinality may be equal to a green cardinality. The green cardinality may be a cardinality of the plurality of green values. Additionally or alternatively, the green cardinality may be equal to a blue cardinality. The blue cardinality may be a cardinality of the plurality of blue values. Additionally or alternatively, the digital luminance image may be associated with a same number of video virtual channels as the digital image. Additionally or alternatively, a luminance cardinality may the cardinality of the plurality of luminance values. The luminance cardinality may be equal to the red cardinality. Additionally or alternatively, a zero cardinality may be a cardinality of the zero virtual channel. the zero cardinality may be equal to the red cardinality.

On Step 130, a luminance based output may be obtained. In some exemplary embodiments, luminance processing a digital luminance image may yield the luminance based output. Additionally or alternatively, the luminance based output may be an output of a digital luminance image processing algorithm.

In some exemplary embodiments, the luminance based output may comprise an output digital luminance image. In those embodiments, Step 135 may be performed. In some exemplary embodiments, an output digital luminance image may be a viewable digital image associated with a satisfactory visual appearance. Additionally or alternatively, the output digital luminance image may comprise a digital representation of an output image. Put differently, In some exemplary embodiments, a computerized apparatus may be configured to luminance process an image. Additionally or alternatively, the computerized apparatus may be configured to provide a luminance processed image associated with the satisfactory visual appearance. In order to provide the luminance processed image, Step 135 may be performed.

On Step 135, a group comprising one or more chrominance video virtual channels may be added to the luminance based output. More specifically, the luminance based output may comprise an output digital luminance image. A chrominance video virtual channel may be added to the output digital luminance image. Additionally or alternatively, the chrominance video virtual channel may be associated with a plurality of chrominance values. Additionally or alternatively, a chrominance video virtual channel may be a U video virtual channel, a V video virtual channel, or the like. In some exemplary embodiments, the U video virtual channel may be based on a U portion of an image. Additionally or alternatively, a plurality of U values may be associated with the U video virtual channel. Additionally or alternatively, the V video virtual channel may be based on a V portion of the image. Additionally or alternatively, a plurality of V values may be associated with the V video virtual channel. Additionally or alternatively, the group may comprise the U video virtual channel, the V video virtual channel, or the like. Additionally or alternatively, one or more chrominance vectors may be added to the luminance based output. Additionally or alternatively, one or more chrominance values may be added to the luminance based output. In some exemplary embodiments, the luminance based output may comprise an output intensity set. Additionally or alternatively, a chrominance set, a chrominance vector, a plurality of chrominance values, or the like, may be added to the output intensity set. Additionally or alternatively, the output intensity set may comprise a plurality of processed luminance values. In some exemplary embodiments, a U value comprised by the plurality of U values may be indicative of a difference between a blue intensity in a coordinate in the image and a luminance intensity in the coordinate. Additionally or alternatively, a V value comprised by the plurality of V values may be indicative of another difference between a red intensity in the coordinate in the image and the luminance intensity in the coordinate. In some exemplary embodiments, the plurality of chrominance values may be obtained based on a digital image. The digital image may be associated with a digital representation of an image. Additionally or alternatively, the digital luminance image may be associated with a digital luminance representation of the image. In some exemplary embodiments, a chrominance value comprised by the plurality of chrominance values may be constant, may be randomly selected, may be an output of another digital image processing algorithm, or the like. It may be noted that the output digital luminance image may be converted to another format such as RGB if required.

As an example, a computerized apparatus may be configured to luminance process a digital luminance image. The digital luminance image may represent an image. In some exemplary embodiments, an output of luminance processing the digital luminance image may comprise a version of the image. The version of the image may comprise an edge of an object displayed in the image. Additionally or alternatively, the edge may be displayed in a first color in the version of the image. Additionally or alternatively, a coordinate in the image not displaying one or more edges of one or more objects displayed in the image may be displayed in a second color in the version of the image. Additionally or alternatively, luminance processing the digital luminance image may comprise a convolution operation. The convolution operation may be based on a plurality of luminance values associated with the digital luminance image. Additionally or alternatively, a luminance based output may be associated with an output digital luminance image. The output digital luminance image, when rendered, may display the version of the image to a user. Additionally or alternatively, the output digital luminance image may be associated with a plurality of processed luminance values. Additionally or alternatively, the output digital luminance image may be associated with a plurality of chrominance values. Additionally or alternatively, a chrominance value comprised by the plurality of chrominance values may be equal to a constant value representing the second color. It may be noted that in this example a format of the output digital image may be a YUV format. In case that the computerized apparatus is configured to output an image in another format, the output digital image may be converted to the other format.

As another example, in some exemplary embodiments, a computerized apparatus may be configured to luminance process a digital luminance image. The digital luminance image may represent an image. In some exemplary embodiments, a luminance based output may be a result of luminance processing the digital luminance image. The luminance based output may be associated with a version of the image. The version of the image may be a sharper version of the image. In some exemplary embodiments, a digital image may be obtained based on the image. The digital luminance image and the digital image may both represent the image. Additionally or alternatively, a plurality of luminance values may be obtained based on the digital image and may be associated with the digital luminance image. In some exemplary embodiments, processing the digital luminance image in order to provide the version of the image may comprise performing a convolution of the plurality of luminance values associated with the digital luminance image and a mask. Additionally or alternatively, providing a sharper version of the image may comprise luminance processing the digital luminance image to a plurality of processed luminance values. Additionally or alternatively, an output digital luminance image may be associated with the plurality of processed luminance values. Additionally or alternatively, a plurality of chrominance values may be obtained based on the digital image and may be associated with the output digital luminance image. In some exemplary embodiments, the output digital luminance image, when rendered, may display the sharper version of the image. Put differently, the digital image may comprise a Y video virtual channel and two chrominance video virtual channels. Additionally or alternatively, the Y video virtual channel may be replaced by an output Y video virtual channel be associated with the plurality of processed luminance values. Hence, the sharper image may be associated with the plurality of chrominance values and the plurality of processed luminance values.

It may be noted, that in some cases, luminance processing a digital luminance image may comprise analyzing the digital luminance image in order to obtain information thereon. Additionally or alternatively, a luminance based output may comprise the information. As an example, the information may comprise one or more coordinates of one or more objects displayed in the digital luminance image, of one or more types of the one or more objects, or the like. In those cases, the luminance based output may not comprise an output digital luminance image. Additionally or alternatively, there may not be a need to add a chrominance vector to the luminance based output.

On Step 140, a luminance based output may be utilized. In some exemplary embodiments, utilizing the luminance based output may comprise displaying a portion of the luminance based output to a user, providing another portion of the luminance based output to another computerized apparatus, or the like. As an example, in some exemplary embodiments, a digital luminance image processing algorithm may be configured to provide information regarding objects displayed within an image. Additionally or alternatively, the luminance based output may comprise one or more coordinates of one or more bounding boxes. A bounding box comprised by the one or more bounding boxes may bound an image of an object displayed in the image. Additionally or alternatively, a first coordinate comprised by the one or more coordinates may comprise information regarding a left corner and a top corner of the bounding box while another coordinate comprised by the one or more coordinates may comprise information regarding a right corner and a bottom corner of the bounding box. Additionally or alternatively, the luminance based output may comprise information regarding one or more people displayed in the image, such as names of the people, their age, or the like. In that example, utilizing the luminance based output may comprise displaying to the user an output digital image comprising one or more coordinates, comprising information regarding a people displayed in the image, or the like. Additionally or alternatively, the information may be added as another layer to a digital image representing the image.

As an example, in some exemplary embodiments, luminance processing an image may be based on a digital luminance image. The luminance processing may result in a blurred image. The digital luminance image may comprise a digital luminance representation of the image. The blurred image may look blurred to a user compared to the image. In some exemplary embodiments, based on the image, a plurality of luminance values may be obtained. Additionally or alternatively, the digital luminance image may be associated with the plurality of luminance values. Additionally or alternatively, the digital luminance image may be associated with a single video virtual channel. The single video virtual channel may be a Y video virtual channel. Additionally or alternatively, the Y video virtual channel may be associated with the plurality of luminance values. Additionally or alternatively, as may exemplified at Step 120 of FIG. 1, the digital luminance image may be luminance processed. Additionally or alternatively, luminance processing the digital luminance image may comprise processing the plurality of luminance values to a plurality of processed luminance value. A processed luminance value comprised by the plurality of processed luminance values may be comprised by a result of performing a convolution of a portion of the plurality of luminance values and a mask. As a result, a luminance based output may comprise the plurality of luminance processed luminance values. In some exemplary embodiments, as may be exemplified by Step 135, a plurality of chrominance values may be obtained based on the image. Additionally or alternatively, the plurality of chrominance values may be added to the luminance based output. As a result, the luminance based output may comprise an output digital luminance image that may look blurred to a user compared to the image. The output digital luminance image may comprise an output digital luminance representation of the blurred image. The output digital luminance representation of the image, when rendered, may be associated with a satisfactory visual appearance compared to the image and based on mask.

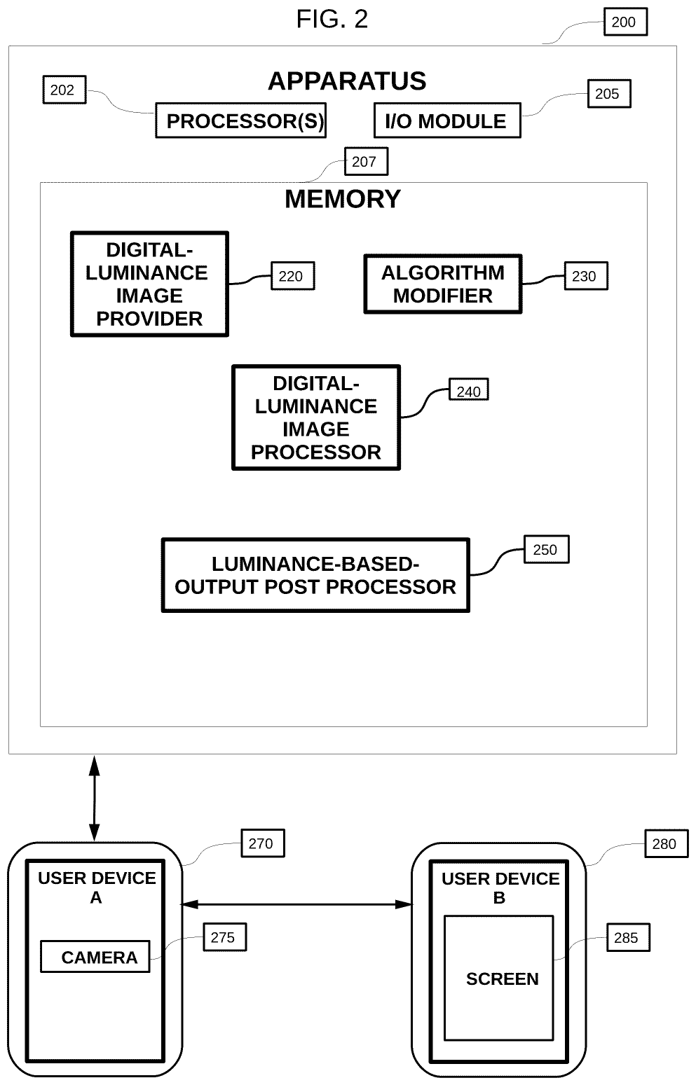

Referring now to FIG. 2 showing a block diagram of an apparatus, in accordance with some exemplary embodiments of the disclosed subject matter.

In some exemplary embodiments, an Apparatus 200 may be a computerized device configured to luminance process a digital luminance image. Additionally or alternatively, Apparatus 200 may be configured to obtain one or more digital luminance images, to luminance process one or more digital luminance images, to provide one or more luminance based outputs, or the like. In some exemplary embodiments, luminance processing a digital luminance image may comprise invoking a digital luminance image processing algorithm with an input comprising the digital luminance image, wherein the digital luminance image processing algorithm is configured to output a luminance based output. In some exemplary embodiments, obtaining the digital luminance image may comprise obtaining a digital image from a light sensor, from a file, from a socket, or the like. Additionally or alternatively, the digital luminance image may be obtained based on the digital image. In some exemplary embodiments, the digital luminance image may be associated with a digital luminance representation of an image. Additionally or alternatively, the digital luminance image may be associated with an additional information. Additionally or alternatively, the digital luminance representation of the image may consist a single video virtual channel. Put differently, In some exemplary embodiments, the digital luminance image may be associated with a video information and the additional information. The video information may consist the single video virtual channel. Additionally or alternatively, the single video virtual channel may be a Y video virtual channel. Additionally or alternatively, the Y video virtual channel may consist one or more luminance values. Additionally or alternatively, the additional information may comprise information regarding the light sensor, regarding the file, or the like. Additionally or alternatively, the additional information may comprise information such as a model of the light sensor, a format utilized by the light sensor, another format associated with the file, or the like.

In some exemplary embodiments, Apparatus 200 may comprise one or more Processor(s) 202. Processor(s) 202 may comprise one or more Central Processing Units (CPUs), one or more General Processing Units (GPUs), one or more Tensor Processing Units (TPUs), one or more microprocessors, one or more electronic circuits, one or more Integrated Circuits (ICs), or the like. Additionally or alternatively, Processor(s) 202 may be utilized to perform computations required by Apparatus 200 or any of its subcomponents.

In some exemplary embodiments, Apparatus 200 may comprise an Input/Output (I/O) module 205. I/O Module 205 may be utilized in order to provide an output or to obtain an input. As an example, I/O Module 205 may be utilized in order to obtain one or more digital luminance images from a light sensor, such as a camera, such as a Camera 275 of a User Device A 270, from a hard disk, or the like. Additionally or alternatively, I/O Module 205 may be utilized in order to provide one or more luminance based outputs to a User Device 280, or the like. Additionally or alternatively, User Device 270 may be configured to provide one or more digital luminance images to Apparatus 200, to provide one or more digital images to Apparatus 200, or the like.

In some exemplary embodiments, Apparatus 200 may comprise Memory 207. Memory 207 may be a hard disk drive, a Flash disk, a Random Access Memory (RAM), a memory chip, or the like. In some exemplary embodiments, Memory 207 may retain program code operative to cause Processor(s) 202 to perform one or more acts, one or more operations, or the like, associated with any of the subcomponents of Apparatus 200.

In some exemplary embodiments, Memory 207 may comprise a Digital Luminance Image Provider 220. In some exemplary embodiments, Digital Luminance Image Provider 220 may be configured to provide a plurality of digital luminance images.

In some exemplary embodiments, Digital Luminance Image Provider 220 may be configured to provide a digital luminance image based on a digital image. Additionally or alternatively, the digital image may comprise a digital representation of an image. In some exemplary embodiments, the digital luminance image may be associated with a plurality of luminance values. In some cases, such as if the digital representation is in YUV format, in a Y′UV format, or the like. The plurality of luminance values may be identical to a Y video virtual channel comprised by the digital representation, to a Y′ virtual channel comprised by the digital representation, or the like. Additionally or alternatively, in case that the digital representation is in another format, a luminance value comprised by the plurality of luminance values may be calculated based on one or more values comprised by the digital representation. In case that the digital luminance image comprises a single video virtual channel, a Y video virtual channel, the digital luminance image may be in a Y format.

In some exemplary embodiments, Digital Luminance Image Provider 220 may be configured to associate the digital luminance image with one or more pluralities of dummy values. A plurality of dummy values may comprise a plurality of zeros. Additionally or alternatively, a plurality of dummy values may comprise the plurality of luminance values, may be equal to the plurality of luminance values, or the like. In some exemplary embodiments, the digital luminance image may be in a YX format. Additionally or alternatively, a “Y” in the word “YX” may indicate that the digital luminance image be associated with the Y video virtual channel, the Y′ virtual channel, or the like. A Y video virtual channel may be associated with the plurality of luminance values. Additionally or alternatively, the letter “X” in the term “YX” may indicate that the digital luminance image may be associated with additional video virtual channel. The additional video virtual channel may be a dummy video virtual channel associated with a plurality of dummy values. Additionally or alternatively, the dummy video virtual channel may be another Y video virtual channel associated with the plurality of luminance values. Additionally or alternatively, the dummy video virtual channel may be a zero virtual channel. In some exemplary embodiments, a zero virtual channel may be associated with a plurality of values, each of which may be equal to zero.

As an example, in some exemplary embodiments, Digital Luminance Image Provider 220 may be configured to provide a digital luminance image in a Y00 format. Additionally or alternatively, providing the luminance image in the Y00 format may comprise providing a Y video virtual channel. Additionally or alternatively, providing the luminance image in the Y00 format may comprise providing two zero virtual channels, each of which may comprise a number of zeroes. The number of zeros associated with a zero video virtual channel may be equal to the number of luminance values associated with the Y video virtual channel.

In some exemplary embodiments, providing a digital luminance image may comprise obtaining a digital image. The digital image may be associated with one or more color video virtual channels. In some exemplary embodiments, the digital image may be in an RGB format, in a BGR format, in a BGR plus alpha (BGRA) format, in a RGB plus depth format (RGB+D), or the like. In some exemplary embodiments, Digital Luminance Image Provider 220 may be configured to obtain a luminance value in a Y format by utilizing a formula such as y=0.299×r+0.587×g+0.114×b. In that formula, wherein y may denote the luminance value, wherein r may denote a red value, wherein g may denote a green value and wherein b may denote a blue value. Additionally or alternatively, the luminance value may be indicative of an intensity of a luminance in a coordinate within the image. Additionally or alternatively, the red value may be indicative of another intensity of Red in the coordinate. Additionally or alternatively, the green value may be indicative of an intensity of Green in the coordinate. Additionally or alternatively, the blue value may be indicative of an intensity of Blue in the coordinate. Additionally or alternatively, a luminance vector may be obtained from the digital image by utilizing another formula such as Y=0.299×R+0.587×G+0.114×B, yielding a Y video virtual channel. In the other formula, Y may denote the luminance vector, R may denote a vector comprising values of red, G may denote a vector comprising values of green and B may denote a vector comprising values of blue. In some exemplary embodiments, Digital Luminance Image Provider 220 may be configured to provide the digital luminance image in a YX format. In that case, a number of dummy video virtual channels may be equal to the number of color video virtual channels minus one.

In some exemplary embodiments, Memory 207 may comprise an Algorithm Modifier 230. Algorithm Modifier 230 may be configured to modify a digital image processing algorithm to a digital luminance image processing algorithm. In some exemplary embodiments, the digital image processing algorithm may be configured to process an input comprising a digital image. Additionally or alternatively, the digital image may be associated with a digital representation of an image. Additionally or alternatively, the digital representation of the image may be associated with two or more color sets. Additionally or alternatively, the digital image processing algorithm may be configured to process an input comprising two or more video virtual channels. Additionally or alternatively, the digital image processing algorithm may be configured to output an output.

In some exemplary embodiments, a digital luminance image processing algorithm may be configured to luminance process an input comprising a digital luminance image. Additionally or alternatively, the digital luminance image may be associated with a digital luminance representation of an image. Additionally or alternatively, the digital luminance image processing algorithm may be configured to output a luminance based output.

In some exemplary embodiments, a difference between an output of the digital image processing algorithm and a luminance based output of a modified digital image processing algorithm may be below a threshold. Additionally or alternatively, the modified digital image processing algorithm may be the digital luminance image processing algorithm.

In some exemplary embodiments, a digital image processing algorithm may comprise two or more sub processing operations. The digital image processing algorithm may be configured to perform a sub processing operation with each of the video virtual channels associated with a digital image as an input, with each of the vectors associated with the digital image as an input, or the like. Additionally or alternatively, Algorithm Modifier 230 may be configured to modify the digital image processing algorithm to a digital luminance image processing algorithm by removing one or more input channels from the digital image processing algorithm. Additionally or alternatively, one or more sub processing operations may be eliminated while processing, removed, or the like, resulting in the digital luminance image processing algorithm that may be configured to perform a sub processing operation only once per digital luminance image. Additionally or alternatively, Apparatus 200 may be configured to invoke the digital luminance image processing algorithm with an input comprising a Y video virtual channel. Such invocation may comprise performing the single sub processing operation.

In some exemplary embodiments, a digital image may be associated with a group of one or more color sets. Additionally or alternatively, the digital image may represent an image associated with a width W and a height H. Additionally or alternatively, a digital luminance image may represent the image. Additionally or alternatively, a luminance cardinality may be a cardinality of a plurality of luminance values associated with the digital luminance image. The luminance cardinality may be W×H. Additionally or alternatively, a color cardinality may be another cardinality of the group of one or more color sets. In some exemplary embodiments, the color cardinality may be C×W×H, wherein C may denote the number of color sets comprised by the group. Additionally or alternatively, the color cardinality may be C times larger than the luminance cardinality. Additionally or alternatively, C×W×H memory units may be required in order retain the other intensity set while processing it. Additionally or alternatively, W×H memory units may be required to retain the luminance intensity set while luminance processing it. In some exemplary embodiments, a memory unit may a byte, two bytes, or the like. In some exemplary embodiments, the memory unit may vary from one computerized apparatus to another apparatus. Additionally or alternatively, a memory unit may depend on the number of bits utilized in order to represent a luminance value, a chrominance value, a color value, or the like. As an example, on Linux™ systems, at 2024, the size needed to hold a color value is 1 byte.

In some exemplary embodiments, Algorithm Modifier 230 may comprise a generative language model, such as Generative Pre Trained Transformer (GPT), Pathways Language Model (PaLM), or the like. Additionally or alternatively, Algorithm Modifier 230 may be configured to process a code of a digital image processing algorithm. Additionally or alternatively, processing the code may comprise utilizing the generative language model in order to modify the code, resulting in a modified code. The modified code may comprise another code of a digital luminance image processing algorithm. Additionally or alternatively, Algorithm Modifier 230 may be configured to compile the modified code of the digital luminance image processing algorithm. As an example, referring to the sub process operation, the digital image processing algorithm may comprise a loop, such as a for loop, a while loop, or the like. The loop may comprise a loop code, that when executed by a processor such as Processor(s) 202 may cause Apparatus 200 to perform the sub process operation. Additionally or alternatively, the loop code may be executed at least two times. Additionally or alternatively, Algorithm Modifier 230 may be configured to change the loop code resulting in that that the modified code may cause Apparatus 200 to execute the sub process operation once per digital luminance image.

In some exemplary embodiments, Algorithm Modifier 230 may be configured to modify a digital filter to a digital luminance filter. In some exemplary embodiments, the digital filter may be configured to digitally filter a digital representation of an image. In some exemplary embodiments, the digital filter may be configured to modify one or more pixels associated with the digital representation of the image. Additionally or alternatively, the digital filter may be configured to process an input comprising a data structure. The data structure may comprise C×W×H values. C may denote a number of color vectors, W may denote a width of a digital image, H may denote a height of the digital image, or the like. In some exemplary embodiments, the digital luminance filter may be configured to digitally luminance filter a digital luminance representation of the image. Additionally or alternatively, the digital luminance filter may be configured to luminance filter an input comprising a luminance data structure. The luminance data structure may comprise W×H luminance values. In some exemplary embodiments, Algorithm Modifier 230 may be configured to reduce a number of input video virtual channels of the digital filter from C to one, resulting in the digital luminance filter.

In some exemplary embodiments, Apparatus 200 may be configured to luminance analyze an image. Additionally or alternatively, luminance analyzing the image may comprise utilizing a trained luminance computer vision model. The trained luminance computer vision model may be configured to detect one or more objects displayed in the image, to perform face detection in order to detected one or more faces that may be displayed in the image, to identify one or more facial landmarks of a one or more faces that may be displayed in the image, or the like. In some exemplary embodiments, luminance analyzing the image may comprise obtaining a digital luminance image based on the image. Additionally or alternatively, luminance analyzing the image may comprise executing, invoking, or the like, the trained luminance computer vision model with an input comprising the digital luminance image. As a result, the image may be analyzed based on a plurality of luminance values.

In some exemplary embodiments, Algorithm Modifier 230 may be configured to modify a trained computer vision model to a trained luminance computer vision model. In some exemplary embodiments, the trained computer vision model may be configured to process an input comprising a data structure. The data structure may comprise C×W×H values. C may denote a number of color vectors, W may denote a width of the digital image, H may denote a height of the digital image, or the like. Additionally or alternatively, the trained luminance computer vision model may be configured to luminance process an input comprising a luminance data structure. The luminance data structure may comprise W×H luminance values. In some exemplary embodiments, the data structure may be a tensor having dimensions of 3×W×H, of 3×H×W, H×W×3, of 3×H×W, or the like. Additionally or alternatively, the luminance data structure may be another tensor having another dimensions of 1×W×H, of W×H, of H×W, of H×W×1, or the like. In some exemplary embodiments, the trained computer vision model may comprise weights. Additionally or alternatively, the weights may be a set of numbers. Additionally or alternatively, the weights may be comprised by a result of training a computer vision model to the trained computer vision model. In some exemplary embodiments, utilizing the trained computer vision model with an input comprising the data structure may comprise passing the data structure through the trained computer vision model. Additionally or alternatively, passing the data structure through the trained computer vision model may comprise passing the data structure from a first layer comprised by the trained computer vision model to a second layer comprised by the computer vision model. Additionally or alternatively, passing the data structure from the first layer to the second layer may comprise executing a function. Additionally or alternatively, the function may be executed with an input comprising a portion of the data structure and a portion of the weights. Additionally or alternatively, executing the function may comprise performing one or more operations such as a convolution, a matrix multiplication, or the like. As an example, a convolution may be performed with an input comprising a portion of the data set and a portion of the weights.

In some exemplary embodiments, Algorithm Modifier 230 may be configured to modify a weights to a modified weights, whereby allowing a trained luminance computer vision model to luminance process an input comprising a luminance data structure. In some exemplary embodiments, utilizing a trained luminance computer vision model with an input comprising the luminance data structure may comprise passing the luminance data structure through the trained luminance computer vision model. Additionally or alternatively, passing the luminance data structure through the trained luminance computer vision model may comprise passing the luminance data structure from a first luminance layer comprised by the trained computer vision model to a second luminance layer comprised by the computer vision model. Additionally or alternatively, passing the luminance data structure from the first luminance layer to the second luminance layer may comprise executing another function. Additionally or alternatively, the other function may be executed with a luminance input. Additionally or alternatively, the luminance input may comprise a portion of the luminance data structure and a portion of the modified weights. Additionally or alternatively, executing the other function may comprise performing one or more luminance operations such as a luminance convolution, a luminance matrix multiplication, or the like. As an example, a luminance convolution may be performed with an input comprising a portion of the luminance data set and a portion of the modified weights. In some exemplary embodiments, the trained computer vision model and the trained luminance computer vision model may be configured to perform a same task. The same task may be to detect an object displayed in the image, to identify one or more body landmarks of an animal displayed in the image, or the like. In some exemplary embodiments, a luminance matrix multiplication may refer to the operation of multiplying a luminance representation of an image and a mask matrix.

In some exemplary embodiments, in order to avoid modifying a digital image processing algorithm, a digital luminance image in a YX format may be utilized. Additionally or alternatively, Digital Luminance Image Provider 220 may be configured to provide the digital luminance image in the YX format. Additionally or alternatively, a digital luminance image processing algorithm may be identical to the digital image processing algorithm. Additionally or alternatively, the digital image processing algorithm may be configured to process an input comprising a number of video virtual channels, each of which may be associated with a plurality of color values. Another number of dummy video virtual channels denoted by X may be equal to the number of video virtual channels minus 1. In some exemplary embodiments, an input comprising a Y video virtual channel and the dummy video virtual channels may be provided as in input to the digital image processing algorithm. In some exemplary embodiments, processing the digital luminance image may comprise performing a sub processing operation. Additionally or alternatively, the sub processing operation may be repeated the number of times, once per each video virtual channel. In those embodiments, X may denote a set comprising one or more video virtual channels.

In some exemplary embodiments, a digital luminance image may be associated with a luminance vector, may be associated with a Y group, may be associated with a Y video virtual channel, may be associated with a plurality of luminance values, or the like. Additionally or alternatively, the Y video virtual channel may be obtained based on a digital image. Additionally or alternatively, rendering the digital luminance image may result in an image with an unsatisfactory visual appearance compared to rendering the digital image. In some exemplary embodiments, the unsatisfactory visual appearance may refer to a situation in which an assessment method configured to measure a difference between the digital image and the digital luminance image may result in a result below a threshold. Additionally or alternatively, the assessment method may be a Structural Similarity Index (SSIM), or the like. In some exemplary embodiments, adding a plurality of chrominance values to the digital luminance image may yield an output digital luminance image. The output digital luminance image, when rendered, may result in another output image with a satisfactory visual appearance compared to the digital image. Additionally or alternatively, the plurality of chrominance values may be obtained based on the digital image. Additionally or alternatively, in case that the digital image is in a YUV format, in a Y′UV format, or the like, the plurality of chrominance values may be copied from the digital image. Additionally or alternatively, in case that the digital image is in another format, the plurality of chrominance values may be calculated based on the digital image.

In some exemplary embodiments, Memory 207 may comprise a Digital Luminance Image Processor 240. Digital Luminance Image Processor 240 may be configured to luminance process one or more digital luminance images. Additionally or alternatively, Digital Luminance Image Processor 240 may be configured to utilize a digital luminance image processing algorithm. Additionally or alternatively, Digital Luminance Image Processor 240 may be configured to output one or more luminance based outputs. In some exemplary embodiments, a digital luminance image comprised by the one or more digital luminance images may represent an image. Additionally or alternatively, the image may be luminance processed based on a plurality of luminance values associated with the digital luminance image. In some exemplary embodiments, luminance processing the image may comprise causing processor 202 to execute, to invoke, or the like, the digital luminance image processing algorithm with an input comprising the digital luminance image. In some exemplary embodiments, the digital luminance image processing algorithm may be a digital luminance filter. Additionally or alternatively, the digital luminance image processing algorithm may be a trained luminance computer vision model. Additionally or alternatively, the digital luminance image may be in a Y format. Additionally or alternatively, a digital luminance image may be associated with a digital luminance representation of an image.

In some exemplary embodiments, Digital Luminance Image Processor 240 may be configured to luminance filter a digital luminance image, representing an image. In some exemplary embodiments, luminance filtering the digital luminance image may comprise utilizing, invoking, executing, or the like, a digital luminance filter with an input comprising the digital luminance image. The digital luminance image may be associated with a digital luminance representation of the image. In some exemplary embodiments, the digital luminance filter may comprise an FFT filter, a median filter, or the like. Additionally or alternatively, the digital luminance filter may be configured to luminance process an input comprising the digital luminance image. Additionally or alternatively, the digital luminance image may be associated with a single video virtual channel. The single video virtual channel may be a Y video virtual channel. In some exemplary embodiments, digitally filtering the digital luminance image may result in a sharper output digital luminance image, in a blurred output digital luminance image, in a less noisy output digital luminance image, or the like. Additionally or alternatively, digitally filtering the digital luminance image may comprise performing a convolution of a matrix representing the digital luminance image with a mask matrix.

In some exemplary embodiments, Memory 207 may comprise a Luminance Based Output Post Processor 250. Luminance Based Output Post Processor 250 may be configured to add one or more chrominance vectors to a luminance based output. Additionally or alternatively, Luminance Based Output Post Processor 250 may be configured to add a plurality of chrominance values to the luminance based output. In some exemplary embodiments, in case that an obtained digital image is in YUV format, or the like, the plurality of chrominance values may be obtained directly from the obtained digital image. Additionally or alternatively, in case that the obtained digital image is in RGB format, BGR format, or the like, the obtained digital image may comprise three color vectors. In that case, the one or more chrominance vectors may be obtained from the obtained digital image by converting three color vectors to one or more chrominance values.

In some exemplary embodiments, it may be desired to configure Apparatus 200 to provide, as an output, a luminance based output comprising an output digital luminance image to User Device 280. Additionally or alternatively, the output digital luminance image may be associated with a satisfactory visual appearance compared to an obtained digital image, such as the digital image of Step 100 at FIG. 1. Additionally or alternatively, the output digital luminance image may be displayed to a user. Additionally or alternatively, the output digital luminance image may be displayed on Screen 285. In some exemplary embodiments, in order to provide the output digital luminance image, Luminance Based Output Post Processor 250 may be configured to add a plurality of chrominance values to the luminance based output. In some exemplary embodiments, Luminance Based Output Post Processor 250 may be configured to obtain a plurality of chrominance values based on an image. Additionally or alternatively, Luminance Based Output Post Processor 250 may be configured to add the plurality of chrominance values or a portion thereof to a luminance based output comprising the output digital luminance image.

In some exemplary embodiments, Apparatus 200 may be configured to utilize a digital luminance image processing algorithm in order to analyze an image. Additionally or alternatively, Apparatus 200 may be configured to output a luminance based output. Additionally or alternatively, the luminance based output may comprise an output digital luminance image. Additionally or alternatively, the output digital luminance image, when rendered, may be associated with a satisfactory visual appearance compared to the image and based on the digital luminance image processing algorithm. In some exemplary embodiments, the satisfactory visual appearance may refer to a situation in which an assessment measurement configured to measure an output difference between the output digital luminance image and the image may be below an output threshold. In some exemplary embodiments, Apparatus 200 may be configured to utilize Luminance Based Output Post Processor 250. Luminance Based Output Post Processor 250 may be configured to post process a luminance based output. In some exemplary embodiments, Apparatus 200 may be configured to obtain a digital image representing the image. Additionally or alternatively, a Y group may be obtained based on the digital image in order to be luminance processed. Additionally or alternatively, post processing the luminance based output may comprise obtaining a plurality of chrominance values based on the digital image. Additionally or alternatively, post processing the luminance based output may comprise adding the plurality of chrominance values to the luminance based output yielding that the luminance based output comprises a processed Y group and the plurality of chrominance values. Additionally or alternatively, the processed Y group and the plurality of chrominance values may be comprised by the output digital luminance representation of the image.

As an example, Apparatus 200 may be configured to detect one or more edges of one or more objects displayed in an obtained digital image. The obtained digital image may be obtained from a light sensor such as a camera, from a file, or the like. As an example, the camera may be Camera 275. Additionally or alternatively, the obtained digital image may be converted to a digital luminance image. Additionally or alternatively, processing the digital luminance image may yield a luminance based output. Additionally or alternatively, the luminance based output may comprise an output digital luminance image. The output digital luminance image, when displayed to one or more users, may display an edge of an object displayed in the obtained digital image. The edge may be displayed in a first color. Additionally or alternatively, a reminder of the output digital luminance image may be colored in a second color. In some exemplary embodiments, the reminder of the output digital image may comprise one or more reminder pixels. Additionally or alternatively, a reminder pixel comprised by the one or more reminder pixels may not be comprised by the one or more edges. In some exemplary embodiments, the one or more reminder pixels may be colored to the second color. As an example, in case that the second color is black, and in case that the format of the luminance based output is a YUV format, Luminance Based Output Post Processor 250 may be configured to set a chrominance value to 128. In some exemplary embodiments, the chrominance value may be comprised by a U chrominance vector, by a V chrominance vector, or the like. In some exemplary embodiments, each value comprised by the U or V chrominance vectors may be set to 128. It may be noted that in case that Apparatus 200 is configured to output the output digital image in a format other than YUV, the luminance based output may be converted to the other format.

In some exemplary embodiments, Apparatus 200 may be configured to luminance train a luminance computer vision model. Additionally or alternatively, luminance processing a plurality of digital luminance images may yield the trained luminance computer vision model. Additionally or alternatively, the trained luminance computer vision model may be configured to luminance analyze an input comprising a digital luminance image. The digital luminance image may be associated with a tensor having a shape of [1,W,H], of [W,H], or the like, wherein W may denote a width of an image and H may denote a height of the image. Additionally or alternatively, the digital luminance image may be associated with a vector comprising W×H entries, a two dimensional matrix having a shape of [W,H], or the like, wherein ‘x’ may denote a product operation. Additionally or alternatively, the trained luminance computer vision model may be configured to luminance analyze an input comprising a Y video virtual channel associated with W×H elements, each of which may represent a luminance value in one or more coordinates in the image. Additionally or alternatively, the trained luminance computer vision model may be configured to analyze an input comprising a plurality of luminance values. Additionally or alternatively, a number of the luminance values may be W×H. Additionally or alternatively, the trained luminance computer vision model may be utilized in order to analyze one or more unseen images.

In some exemplary embodiments, luminance training a luminance computer vision model may comprise obtaining one or more luminance datasets. Additionally or alternatively, a dataset may comprise a plurality of digital luminance images. Additionally or alternatively, Apparatus 200 may be configured to prepare a luminance dataset. In some exemplary embodiments, a luminance dataset may comprise a plurality of digital luminance images. In some cases, a digital luminance image comprised by the luminance dataset may be in a Y format. Additionally or alternatively, Digital Luminance Image Provider 220 may be configured to augment the digital luminance image. Additionally or alternatively, augmenting the digital luminance image may comprise cropping, rotating, or the like, the digital luminance image, resulting in an additional one or more digital luminance images, allowing training the luminance computer vision model based on another dataset that may be larger than the dataset. It may be noted, that cropping a digital luminance image, rotating a digital luminance image, or the like, may be performed based on a single Y video virtual channel associated with the digital luminance image. In some exemplary embodiments, augmenting the digital luminance image may comprise generating a brighter digital luminance image compared to the digital luminance image. Additionally or alternatively, generating the brighter digital luminance image may comprise increasing values of one or more luminance values comprised by the plurality of luminance values. Additionally or alternatively, a bounding box displaying an object may be brighter. In some exemplary embodiments, augmenting the digital luminance image may comprise generating a darker digital luminance image compared to the digital luminance image. Additionally or alternatively, generating the darker digital luminance image may comprise decreasing values of values of one or more luminance values comprised by the plurality of luminance values. Additionally or alternatively, the bounding box displaying may be darker.

In some exemplary embodiments, in order to luminance train a luminance computer vision model, Digital Luminance Image Processor 240 may be configured to execute a luminance computer vision model plurality of times, each time with an input comprising a different digital luminance image. Additionally or alternatively, Digital Luminance Image Processor 240, may be configured to execute a modified computer vision model a plurality of times, each time with an input comprising a different digital luminance image. In some exemplary embodiments, a luminance based output may comprise one or more weights, allowing the computerized apparatus or another computerized apparatus to utilize the weights in order to luminance analyze another digital luminance image. Put differently, luminance processing a plurality of digital luminance images may comprise invoking the luminance computer vision model a plurality of times, each time with an input comprising a different digital luminance image. As a result of processing the plurality of digital luminance images, the luminance based output may comprise weights. The weights may be utilized in order to analyze an unseen image. The unseen image may be represented by a digital luminance image not comprised by a dataset.

In some exemplary embodiments, Apparatus 200 may be configured to provide a live avatar of an object. In some exemplary embodiments, providing the live avatar may refer to a process of creating an animated representations of an object. Additionally or alternatively, providing the live avatar may refer to another process of creating a virtual character that may mimic a real time movements, expressions, appearance, or the like, of the object. In some exemplary embodiments, the object may be a person, a dog, a bird, a baby, or the like. Additionally or alternatively, the object may be a face of the person, a face of the dog, a face of the bird, a face of the baby, or the like.

In some exemplary embodiments, providing a live avatar may comprise obtaining a series of digital luminance images. Additionally or alternatively, providing the live avatar may comprise luminance analyzing one or more digital luminance images comprised by the series of digital luminance images. Additionally or alternatively, providing the live avatar may comprise identifying an object displayed in the series of digital luminance images. In some exemplary embodiments, the object may be mapped to an avatar model. In some exemplary embodiments, providing the live avatar may comprise replacing the object or a portion thereof with the live avatar. In some exemplary embodiments, replacing the object with the live avatar may comprise animating the live avatar instead of a portion of the object. Put differently, in case that the object is displayed in an image, the live avatar may be displayed, rendered, or the like, instead of the portion of the object. In some exemplary embodiments, the live avatar may replicate a facial movements of the object, arms movements of the object, lips movements of the object, gestures of the object, or the like.

In some exemplary embodiments, providing the live avatar may comprise utilizing one or more digital luminance image processing algorithm such as luminance Active Shape Models (ASM), luminance Shape Predictor Algorithm (SPA), luminance Face Alignment Network (FAN), luminance Multi task Cascaded Convolutional Networks (MTCN), luminance Single Shot Scale invariant Face Detector (S3FD), luminance filtering algorithms such as luminance FFT, or the like.

In some exemplary embodiments, luminance ASM may be a luminance computer vision model configured to perform a same task as ASM. Additionally or alternatively, luminance ASM may be configured to detect one or more facial landmarks of a face displayed in an image. An input to luminance ASM may comprise a digital luminance image representing the image.

In some exemplary embodiments, luminance SPA may be a luminance computer vision model configured to perform a same task as SPA. Additionally or alternatively, luminance SPA may be configured to detect one or more facial landmarks of a face displayed in an image. An input to luminance SPA may comprise a digital luminance image representing the image.

In some exemplary embodiments, luminance FAN may be a luminance computer vision model configured to perform a same task as FAN. Additionally or alternatively, luminance FAN may be configured to estimate a 3d pose of an object displayed in an image. An input to luminance FAN may comprise a digital luminance image representing the image.

In some exemplary embodiments, luminance MTCN may be a luminance computer vision model configured to perform a same task as MTCN. Additionally or alternatively, luminance MTCN may be configured to detect a face displayed in an image, to align the face, to extract a facial features of the face, or the like. An input to luminance FAN may comprise a digital luminance image representing the image.

In some exemplary embodiments, Digital Luminance Image Provider 220 may be configured to provide a series of digital luminance images based on a series of digital images. The series of digital images may be obtained from a light sensor, from a file, from a remote computerized apparatus, or the like. Additionally or alternatively, a digital luminance image comprised by the series of digital luminance images may be provided based on a digital image comprised by the series of digital images. In some exemplary embodiments, the series of digital images may be obtained in a YUV format, in a Y′UV format, or the like. Additionally or alternatively, the series of digital image may be obtained in a YUV 4:2:1 format, YUV 4:2:0 format, or any other subsampling of YUV. In those embodiments, Digital Luminance Image Provider 220 may be configured to obtain a Y video virtual channel from a digital image comprised by the series of digital image by copying a plurality of luminance values from the digital image. Additionally or alternatively, a pointer may point to the plurality of luminance values in the digital image. Put differently, in case that the digital image is in a YUV format or in a YUV format with subsampling, conversion of the digital image to another format may be eliminated.

In some exemplary embodiments, Digital Luminance Image Processor 240 may be configured to detect a face of an object displayed in the one or more digital luminance images. Additionally or alternatively Digital Luminance Image Processor 240 may be configured to track the face. Additionally or alternatively, Digital Luminance Image Processor 240 may be configured to perform a facial landmark detection of the face. In some exemplary embodiments, performing the face detection, performing a facial landmark detection, or the like, may be based on a plurality of luminance values. In some exemplary embodiments, facial landmark detection may comprise identifying one or more facial landmarks. Additionally or alternatively, facial landmarks may comprise one or more eye landmarks, one or more eyebrow landmarks, one or more nose landmarks, one or more mouth landmarks, one or more cheek and jaw landmarks, one or more facial contour landmarks, or the like. In some exemplary embodiments, an eye landmark comprised by the one or more eye landmarks may comprise coordinates in a digital luminance image of a corner of an eye, of a center of the eye, an edge of the eye, or the like. Additionally or alternatively, an eyebrow land mark comprised by the one or more eyebrows landmarks may comprise coordinates within the digital luminance image of a start of the eyebrow, the end of the eyebrow, an edge of the eyebrow, or the like. Additionally or alternatively, a nose landmark comprised by the one or more nose landmarks may comprise coordinates within the digital luminance image of a tip of a nose, of a bridge of the nose, of a nostril, or the like. Additionally or alternatively, a mouth landmark comprised by the one or more mouth landmarks may comprise coordinates within the digital luminance image of the corners of a mouth, of a center of a lip, one or more coordinates of a boundary of the lip, or the like. Additionally or alternatively, a cheek and jaw landmark comprised by the one or more cheeks and jaws landmarks may comprise coordinates within the digital luminance image of a portion of a cheek bone, a portion of a chin, a portion of a side of a jaw, or the like. Additionally or alternatively, a face contour comprised by the one or more face contours may comprise one or more coordinates within the digital luminance image, comprised by an outline of the face. In some exemplary embodiments, the outline of the face may comprise a base of a neck, a top of the head, or the like.

In some exemplary embodiments, Digital Luminance Image Processor 240 may be configured to detect a facial landmark by executing a group comprising one or luminance computer vision models. The group may comprise a trained luminance computer vision model such as luminance ASM, luminance SPA, luminance FAN, a luminance Multi task Cascaded Convolutional luminance MTCN, luminance Single Shot Scale invariant Face Detector (luminance S3FD), or the like. In some exemplary embodiments, training the trained luminance computer vision model comprise utilizing a plurality digital luminance images in a Y format. Additionally or alternatively, the trained luminance computer vision model may be an output of Algorithm Modifier 230, wherein an input to Algorithm Modifier 230 may comprise a trained computer vision model. As an example, the trained computer vision model may be ASM and the luminance computer vision model may be luminance ASM. As another example, the trained computer vision model may be FAN and the luminance computer vision model may be luminance FAN.

In some exemplary embodiments, Digital Luminance Image Processor 240 may be configured to detect the facial landmark by executing a group comprising one or computer vision models in an unmodified form. The group may comprise a trained computer vision model such as ASM, SPA, FAN, MTCN, S3FD, or the like. In some exemplary embodiments, the trained computer vision model may have been trained by utilizing one or more digital images, in an RGB format, BGR format, or the like. Nevertheless, Digital Luminance Image Processor 240 may be configured to provide to the trained computer vision model an input comprising a digital luminance image in a Y00 format, in a YYY format, or the like.

In some exemplary embodiments, Digital Luminance Image Processor 240 may be configured to map the one or more detected landmarks to an avatar model. In some exemplary embodiments, mapping a detected landmark may be based on a plurality of luminance values.

In some exemplary embodiments, Digital Luminance Image Processor 240 may be configured to perform an expression analysis of a face displayed in a digital luminance image. In some exemplary embodiments, the expression analysis may be based on one or more facial landmarks previously detected. In some exemplary embodiments, the one or more facial landmarks may be detected based on a plurality of luminance values. Additionally or alternatively, the digital luminance image may be in a Y format, in a YX format, or the like.

In some exemplary embodiments, Apparatus 200 may be comprised by a cloud server, by a remote computerized apparatus, or the like. Additionally or alternatively, User Device 270 may be configured to obtain a group of digital images. Additionally or alternatively, User Device 270 may be configured to detect an object comprised by a portion of the group of digital images. Additionally or alternatively, User Device 270 may be configured to convert a digital image comprised by the portion to a digital luminance image. Additionally or alternatively, User Device 270 may be configured to crop the digital luminance image to a cropped digital luminance image based on the detected object, whereby removing a background from the digital luminance image, removing another object from the digital luminance image, or the like. In some exemplary embodiments, the cropped digital luminance image may be associated with coordinates in the digital luminance image. Additionally or alternatively, the coordinates may define a minimal bounding box with respect to the detected object and the digital image. In some exemplary embodiments, a bounding box with respect to the detected object and the digital image may be a rectangle bounding the object. Additionally or alternatively, the minimal bounding box may be a minimal rectangle, having the smallest area from a set comprising one or more rectangles bounding the object. Additionally or alternatively, User Device 270 may be configured to encode the cropped digital luminance image to an encoded digital luminance image. Additionally or alternatively, User Device 270 may be configured to provide the encoded digital luminance image to Apparatus 200.

In some exemplary embodiments, Apparatus 200 may be configured to obtain an encoded digital luminance image. Additionally or alternatively, Apparatus 200 may be configured to decode the digital luminance image to another digital luminance image. Additionally or alternatively, Apparatus 200 may be configured to provide an avatar based on the decoded digital luminance image. It may be noted, that in some exemplary embodiments, User Device 270 may be configured to provide a plurality of encoded digital luminance image to Apparatus 200. Additionally or alternatively, Apparatus 200 may be configured to provide the live avatar based on a plurality of decoded digital luminance image. As a result, Apparatus 200 may be configured to provide the live avatar based on a plurality of digital luminance images in a Y format, in a Y00 format, or the like.

In some exemplary embodiments, Apparatus 200 may be configured to provide a luminance database comprising a plurality of digital luminance images. The luminance database may be utilized for training a luminance computer vision model. Additionally or alternatively, Digital Luminance Image Provider 220 may be configured to provide the plurality of digital luminance images based on a plurality of digital images. In some exemplary embodiments, Digital Luminance Image Provider 220 may be configured to provide a digital luminance image comprised by the plurality of digital luminance image in a YX format, such as Y00 format, Y0Y format, YYY format, or the like, allowing Apparatus 200 to utilize a standard encoder to encode the digital luminance image and to retain the encoded digital luminance image. In some exemplary embodiments, the standard encoder may be configured to encode a digital image in a YUV format, in a BGR format, in a HUE format, or the like. In some exemplary embodiments, in order to train a luminance computer vision model based on a plurality of digital luminance image in a YX format, only a single Y video virtual channel from each digital luminance image may be utilized.

In some exemplary embodiments, Apparatus 200 may be configured to utilize a luminance codec in order to luminance process a digital luminance image. Additionally or alternatively, the luminance codec may comprise a luminance encoder. The luminance encoder may be configured to luminance encode a digital luminance image to a luminance encoded digital luminance image. Additionally or alternatively, the luminance codec may comprise a luminance decoder. The luminance decoder may be configured to luminance decode the luminance encoded digital luminance image to another digital luminance image. Additionally or alternatively, a difference between the digital luminance image and the other digital luminance image may below a threshold.

In some exemplary embodiments, Algorithm Modifier 230 may be configured to modify a standard encoder to a luminance encoder. In that case, Digital Luminance Image Provider 220 may be configured to provide the digital luminance image in a Y format. Additionally or alternatively, processing the digital luminance image by Luminance Image Processor 240 may comprise luminance encoding a digital luminance image by utilizing a luminance encoder.

In some exemplary embodiments, Apparatus 200 may be configured to luminance process one or more digital images based on one or more digital luminance images. In some exemplary embodiments, luminance processing a digital image based on a digital luminance image may comprise extracting one or more locations of one or more contours comprised by the digital image. Additionally or alternatively, a contour comprised by the digital image may be comprised by the digital luminance image. In some exemplary embodiments, a location of a contour in the digital luminance image may be the location of the contour in the digital luminance image. Additionally or alternatively, further processing the digital image may be based on the digital image. As an example, Apparatus 200 may be configured to luminance encode the digital image. Additionally or alternatively, Digital Luminance Image Provider 220 may be configured to provide the digital luminance image based on the digital image. Additionally or alternatively, Digital Luminance Image Processor 240, may be configured to extract one or more contours displayed in the digital luminance image, resulting in one or more locations of the one or more contours. Additionally or alternatively, Luminance Based Output Post Processor 250 may be configured to encode the digital image based on the one or more locations of the one or more contours. In some exemplary embodiments, encoding the digital image based on the one or more locations may comprise segmenting the digital image to one or more regions. A region comprised by the one or more regions may be 4×4 pixels, 16×16 pixels, 64×64 pixels, 4×8 pixels, 32×16 pixels, 64×4 pixels, 12×5 pixels, 2×8, 17×9 pixels, 112×105 pixels or the like. Additionally or alternatively, a location of a contour may be comprised by the region. In that case, Luminance Based Output Post Processor 250 may be configured to perform high encoding of a portion of the digital image comprised by the region. In some exemplary embodiments, high encoding the portion of the digital image may result in preserving more details while encoding compared to low encoding another region. In some exemplary embodiments, the other region may not comprise the location of the contour, may not comprise another location of another contour, or the like. Additionally or alternatively, another portion of the digital image may be comprised by the other region. Additionally or alternatively, the other portion may be analyzed may be low encoded, resulting in an encoded other region with less details compared to the encoded region.

In some exemplary embodiments, a Y group comprising one or more Y video virtual channels may be obtained. Additionally or alternatively, the Y group may comprise a Y video virtual channel. The Y video virtual channel may be associated with a digital luminance representation of an image. In some exemplary embodiments, the Y group may comprise another Y video virtual channel. The other Y video virtual channel may be associated with another digital luminance representation of another image. As an example, a group of digital images comprising one or more digital images may be comprised by a stream, by a dataset, or the like. Based on the group of digital images, the Y group may be obtained. Additionally or alternatively, the Y video virtual channel may be associated by a digital image in a YUV format, in a Y′UV format, or the like. The digital image may be comprised by the group of digital images. Additionally or alternatively, a digital luminance image processing algorithm may be configured to luminance process an input comprising the Y video virtual channel, the other Y video virtual channel, or the like. In some exemplary embodiments, Apparatus 200 may be configured to luminance process the Y group.

In some exemplary embodiments, an image may be luminance processed. Luminance processing the image may comprise luminance processing a plurality of luminance values. The plurality of luminance values may be associated with a Y video virtual channel. In some exemplary embodiments, luminance processing the Y video virtual channel may yield a luminance based output. Additionally or alternatively, the luminance based output may be utilized. As an example, a user may watch the luminance based output, may obtain information about the image based on the luminance based output, or the like.

In some exemplary embodiments, luminance processing an image may comprise invoking a digital image processing algorithm with an input comprising a Y video virtual channel. Additionally or alternatively, the input may be a luminance input. In some exemplary embodiments, a luminance input may comprise one or more input video virtual channels. An input video virtual channel may comprise a Y video virtual channel, may comprise a dummy video virtual channel, or the like. Additionally or alternatively, the digital image processing algorithm may be configured to process an input associated with a representation the image. Additionally or alternatively, the representation of the image may be based on one or more color video virtual channels. As an example, the representation of the image may be based on an RGB format, may be based on BGR format, or the like. Hence, the digital image processing algorithm may be configured to process an input comprising a number of input video virtual channels. The number of input video virtual channels may be equal to the number of color video virtual channels associated with the representation of the image. In some exemplary embodiments, another number of dummy video virtual channels may be equal to the number of color video virtual channels minus one, yielding that the yet another number of input video virtual channels comprised by the luminance input may be equal to the number of color video virtual channels. Additionally or alternatively, the luminance input may comprise the other number of dummy video virtual channels. In some exemplary embodiments, processing the image may comprise invoking the digital image processing algorithm with the luminance input, although the digital image processing algorithm may be configured to process the image based on an input comprising the one or more color video virtual channels.

In some exemplary embodiments, a dummy group may be obtained. The dummy group may comprise one or more dummy video virtual channels. A dummy video virtual channel comprised by the dummy group may be associated with a number of values. The number of values may be equal to another number of luminance values comprised by a plurality of luminance values. In some exemplary embodiments, the dummy video virtual channel may be associated with a plurality of zero values. Additionally or alternatively, the dummy video virtual channel may be associated with a Y video virtual channel, with the Y video virtual channel, or the like.

In some exemplary embodiments, a digital image processing algorithm may be obtained. Additionally or alternatively, the digital image processing algorithm may be modified to a digital luminance image processing algorithm. The digital luminance image processing algorithm may be configured to luminance process a luminance input as an input. The luminance input may comprise a single input channel, a Y video virtual channel. In those embodiments, processing an image may comprise invoking a digital luminance image processing algorithm with the luminance input as an input.

In some exemplary embodiments, obtaining a Y video virtual channel may comprise obtaining a digital image. Additionally or alternatively, the digital image may be associated with a representation of an image. As an example, a light sensor such as a camera may capture the digital image. In some exemplary embodiments, the digital image may be in a YUV format. In that case, the Y video virtual channel may be associated with a portion of the digital image. In some exemplary embodiments, the digital image may be in a BGR format. In that case, a luminance value associated with the Y video virtual channel in a coordinate may be obtained from the digital image by utilizing a formula such as y=0.299×r+0.587×g+0.114×b, wherein r may denote a value representing red intensity in the coordinate, g may denote another value representing a green intensity in the coordinate, b may denote yet another value representing a blue intensity in the coordinate, or the like.

In some exemplary embodiments, a luminance based output may comprise a plurality of processed luminance values. Additionally or alternatively, the plurality of processed luminance values may be comprised by a result of processing a plurality of luminance values. Additionally or alternatively, a plurality of chrominance values may be obtained based on a digital image. As an example, in case that the digital image comprising a representation of an image in a RGB format, the plurality of chrominance values may be obtained based thereon. Additionally or alternatively, the plurality of chrominance values may comprise a U video virtual channel. Converting RGB values to a U video virtual channel may utilize a formula such as U=0.14713×R 0.28886×G+0.436×B+0.5. Additionally or alternatively, the plurality of chrominance values may comprise a V video virtual channel. Converting RGB values to a U video virtual channel may utilize a formula such as V=0.615×R 0.51498×G 0.10001×B+1.12.

In some exemplary embodiments, a plurality of chrominance values may be associated with two chrominance video virtual channels. A first chrominance video virtual channel may be associated with a plurality of blue difference values. A blue difference value comprised by the plurality of blue difference values may be a difference between a blue measurement and a luminance measurement in a coordinate in the image. Similarly, a second chrominance video virtual channel may be associated with a plurality of red difference values. A red difference value comprised by the plurality of red difference values may be a difference between a red measurement and the luminance measurement in the coordinate in the image.

In some exemplary embodiments, a luminance based output may comprise a plurality of processed luminance values. Additionally or alternatively, the luminance based output may comprise a plurality of chrominance values. In some exemplary embodiments, the plurality of chrominance values may be associated with a blue difference video virtual channel and a red difference video virtual channel. Additionally or alternatively, the plurality of chrominance values may be associated with a U video virtual channel and with a V video virtual channel. In some exemplary embodiments, the plurality of luminance processed luminance values and the plurality of chrominance values may be comprised by an output digital luminance image. In some exemplary embodiments, the output digital luminance image may be rendered. Additionally or alternatively, the output digital luminance image may be associated with a satisfactory visual appearance compared to the image and based on a digital luminance image processing algorithm.

In some exemplary embodiments, luminance processing a plurality of digital luminance images may yield a trained luminance computer vision model. Put differently, training a luminance computer vision model to a trained luminance computer vision model may comprise luminance processing the plurality of digital luminance image. In some exemplary embodiments, a luminance computer vision model may be a computer vision model configured to luminance process an input comprising a single video virtual channel, a Y video virtual channel, per image.

In some exemplary embodiments, a luminance computer vision model may be a luminance processing algorithm. The luminance processing algorithm may be configured to luminance process an input comprising a digital luminance image. Additionally or alternatively, the input may comprise a single Y video virtual channel associated with the digital luminance image. In some exemplary embodiments, the luminance computer vision model may comprise an artificial neural network. The artificial neural network may comprise an input layer. The input layer may comprise W×H artificial neurons. Additionally or alternatively, W may denote a width of an image, H may denote a height of the image. Additionally or alternatively, the digital luminance image may represent the image.

In some exemplary embodiments, training the luminance computer vision model may be based on a plurality of Y video virtual channels. The plurality of Y video virtual channels may be based on a plurality of images. In some exemplary embodiments, training the luminance computer vision model may comprise passing a Y video virtual channel comprised by the plurality of Y video virtual channels through the luminance computer vision model. Based on a result of passing the Y video virtual channel through the luminance computer vision model, an error function may be calculated and output an error value. Additionally or alternatively, in case that the error value is below a threshold, weights associated with the artificial neural network may be updated.

In some exemplary embodiments, processing an image may comprise analyzing the image by utilizing a trained luminance computer vision model. The trained luminance computer vision model may be utilized with an input comprising a digital luminance image representing the image. It may be noted that the input may comprise additional information such as a width and a height of the image, a format of the image, or the like. Additionally or alternatively, the single video virtual channel may be the only portion of the input associated with visual data.

In some exemplary embodiments, the trained luminance computer vision model may be a modified trained computer vision model. The modified trained computer vision model may be a result of modifying a trained computer vision model. Additionally or alternatively, the trained computer vision model may be configured to process an input comprising two or more input video virtual channels.

In some exemplary embodiments, processing an image may comprise filtering the image. Additionally or alternatively, luminance processing the image may comprise utilizing a digital luminance filter with a digital luminance representation of the image as a luminance input. Additionally or alternatively, the digital luminance representation of the image may be associated with a single video virtual channel, a Y video virtual channel. In some exemplary embodiments, the digital luminance filter may be a modified digital filter. The digital filter may be configured to process an input comprising two or more input video virtual channels. Additionally or alternatively, a luminance based output may be a result of invoking the digital luminance filter with the luminance input. The luminance input may comprise the Y video virtual channel. In some exemplary embodiments, the luminance based output may comprise an output digital luminance image. The output digital luminance image may be associated with a luminance filtered representation of the image.

In some exemplary embodiments, processing the image may comprise utilizing a luminance encoder. The luminance encoder may be an encoder configured to process an input comprising a single video virtual channel. Additionally or alternatively, the single video virtual channel may be a Y video virtual channel. In some exemplary embodiments, luminance encoding the digital luminance image may comprise dividing the digital luminance image to blocks. Additionally or alternatively, luminance encoding the digital luminance image may comprise applying transformation algorithms with the Y video virtual channel as an input. A transformation algorithm may be an algorithm such as Discrete Cosine Transform (DCT), Discrete Wavelet Transform (DWT), or the like. Additionally or alternatively, luminance encoding the digital luminance image may comprise applying quantization on the transformed data. Additionally or alternatively, an entropy coding algorithm such as Huffman coding may be applied on the data.

In some exemplary embodiments, a luminance encoder may be configured to luminance encode a Y group comprising two or more Y video virtual channels. A luminance encoded Y group may be comprised by a video stream comprising two or more encoded digital luminance images. In some exemplary embodiments, a computerized apparatus may be configured to utilize such luminance encoder in order to luminance analyze the video stream.

As an example, a surveillance camera product may be configured to obtain one or more digital images. Additionally or alternatively, the surveillance camera product may be configured to obtain a first digital image. Additionally or alternatively. A Y video virtual channel may be obtained based on the first digital image. Additionally or alternatively, the Y video virtual channel may be luminance encoded. Additionally or alternatively, the luminance encoded Y video virtual channel may be comprised by a video stream. The video stream may be streamed to a remote server in order to detect an object displayed in the video stream. In some exemplary embodiments, detecting the object in the video steam may comprise analyzing a portion of the video stream. Additionally or alternatively, the surveillance camera product may be configured to obtain a second image. Additionally or alternatively, a second Y video virtual channel may be obtained based on the second image. Additionally or alternatively, the second Y video virtual channel may be luminance encoded. Additionally or alternatively, an encoded second Y video virtual channel may be comprised by the video stream. In some exemplary embodiments, the remote server may be configured to detect one or more objects displayed in the video stream. Additionally or alternatively, the remote server may be configured to luminance decode one or more luminance encoded digital luminance images comprised by the stream, yielding one or more luminance decoded digital luminance images. A luminance decoded luminance digital image may be luminance analyzed by a trained luminance computer vision model.

As another example, a computerized apparatus may be configured to provide an avatar of a person. The computerized apparatus may be configured to obtain a stream of digital images displaying the person. Additionally or alternatively, a remote computerized apparatus, such as a cloud server, may be configured to detect facial landmarks, body landmarks, or the like, based on a Y video virtual channel. Additionally or alternatively, the computerized apparatus may be configured to obtain a Y group based on the stream of digital images. The Y group may comprise a sequence of Y video virtual channels. Additionally or alternatively, the Y video virtual channel may be comprised by the sequence of Y video virtual channels. Additionally or alternatively, the Y video virtual channel be associated with a corresponding digital image comprised by the stream of digital images. Additionally or alternatively, one or more Y video virtual channels comprised by the sequence of Y video virtual channels may be luminance encoded by utilizing a luminance encoder and may be provided to the remote computerized apparatus as a luminance stream. Additionally or alternatively, the remote computerized apparatus may be configured to obtain the luminance stream comprising a sequence of luminance encoded Y video virtual channels. Additionally or alternatively, the remote computerized apparatus may be configured to luminance decode the luminance stream to a sequence of luminance decoded Y video virtual channels. Additionally or alternatively, the remote computerized apparatus may be configured to luminance process the sequence of luminance decoded Y video virtual channels. Additionally or alternatively, luminance processing the sequence of luminance decoded Y video virtual channels may comprise luminance processing a luminance decoded Y video virtual channel comprised by the sequence of luminance decoded Y video virtual channels. Additionally or alternatively, luminance processing the luminance decoded Y video virtual channel may yield a group comprising one or more coordinate of one or more landmarks. A coordinate of a landmark may be a coordinate in the luminance decoded Y video virtual channel. The coordinate may also be located in a same place in the corresponding digital image. In some exemplary embodiments, the corresponding digital image may be associated with a corresponding luminance encoded digital luminance image comprised by the luminance stream. Additionally or alternatively, the corresponding digital image may be associated with the luminance decoded Y video virtual channel. Additionally or alternatively, the remote computerized apparatus may be configured to provide to the computerized apparatus a group comprising one or more coordinates or a sub group thereof. It may be noted that the luminance decoded Y video virtual channel may be another Y video virtual channel. Additionally or alternatively, the luminance decoded Y video virtual channel may be associated with a digital luminance image. Additionally or alternatively, the digital luminance image may represent an image. Additionally or alternatively, the corresponding digital image may represent the image.

In some exemplary embodiments, a Y group may be group comprising a plurality of Y video virtual channels. At least a sub group of the group may be luminance processed. Additionally or alternatively, a plurality of luminance based outputs may be obtained. Additionally or alternatively, the plurality of Y video virtual channels may be retained on a medium such as on a hard disk. In some exemplary embodiments, a Y video virtual channel may be luminance processed. Processing the Y video virtual channel may comprise luminance encoding the Y video virtual channel. Additionally or alternatively, an encoded Y video virtual channel may be retained on a medium.

In some exemplary embodiments, a luminance based input may be referred to as a luminance input, as a quasi input, or the like. Additionally or alternatively, a digital luminance image may be referred to as a quasi image, as a digital quasi image, or the like. Additionally or alternatively, a luminance based output may be referred to as a quasi output.

The inventor implemented an embodiment of the disclosed subject matter, and exemplified that when invoking a digital filter 1000 times and a digital luminance filter 1000 times in order to measure a time difference between a running time of the digital and a luminance running time of the digital luminance filter. The luminance running time was 0.0070143323750000005 seconds per image. The running time was 0.0104299125. As one may appreciate, the digital luminance filter is 32.75% faster than the digital filter.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non exhaustive list of more specific examples of the computer readable storage medium includes the following: a portable computer diskette, a hard disk, a random access memory (RAM), a read only memory (ROM), an erasable programmable read only memory (EPROM or Flash memory), a static random access memory (SRAM), a portable compact disk read only memory (CD ROM), a digital versatile disk (DVD), a memory stick, a floppy disk, a mechanically encoded device such as punch cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction set architecture (ISA) instructions, machine instructions, machine dependent instructions, microcode, firmware instructions, state setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand alone software package, partly on the user's computer and partly on a remote computer or entirely on the remote computer or server. In the latter scenario, the remote computer ‘ay be connected to the user's’ computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field programmable gate arrays (FPGA), or programmable logic arrays (PLA) may execute the computer readable program instructions by utilizing state information of the computer readable program instructions to personalize the electronic circuitry, in order to perform or more aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a sequence of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform or more the specified functions or acts or carry out combinations of special purpose hardware and computer instructions.

The terminology used herein is for the purpose of describing particular embodiments only, and is not intended to be limiting of the invention. As used herein, the singular one or more “a”, “an” and “the” are intended to include the plural one or more as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

An “or” used therein and/or in the claims is an inclusive or. As an example, the sentence “a priority may be based on an interest level or based on an activity level” indicates that the priority can be based on the interest level. Additionally or alternatively, the sentence indicates that the priority can be based on the activity level. Additionally or alternatively, the sentence indicates that the priority can be based on the interest level and on the activity level.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the one or more disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining a Y group comprising one or more Y video virtual channels, wherein a Y video virtual channel comprised by the Y group is associated with a digital luminance representation of an image, wherein the Y video virtual channel comprises a plurality of luminance values, wherein a luminance value comprised by the plurality of luminance values is indicative to an intensity of luminance in one or more coordinates in the image;
luminance processing a luminance based input to a luminance based output, wherein the luminance based input comprises the Y group, wherein luminance processing comprises utilizing a digital image processing algorithm with an input comprising the luminance based input, whereby processing the image based on the plurality of luminance values; and
utilizing the luminance based output.

2. The method of claim 1, wherein the digital image processing algorithm is configured to process another input, wherein the other input comprises a number of video virtual channels, the method comprises:
obtaining a dummy group, wherein the dummy group is a group comprising another number of dummy virtual channels, wherein the other number of dummy virtual channels is equal to the number minus one, wherein the luminance based input comprises the dummy group, wherein a dummy video virtual channel comprised by the dummy group is selected from a group consisting one of: the Y virtual channel and a zero virtual channel, wherein the zero virtual channel comprises zeros, wherein the number of zeros is equal to the number of luminance's values comprised by the Y virtual channel, wherein the input comprises the Y group and the dummy group.

3. The method of claim 2, wherein the digital image processing algorithm is a digital color image processing algorithm configured to color process a color based input, wherein the color based input comprises a digital color representation of the image, wherein the digital color representation of the image comprises a color group, wherein the color group comprises one or more color video virtual channels, wherein color process the color based input comprises invoking the digital color image processing algorithm, wherein said luminance processing comprises invoking the digital color image processing algorithm with the luminance based input.

4. The method of claim 1, wherein the digital image processing algorithm is a digital color image processing algorithm configured to color process a color based input, the method comprises:
modifying the digital image processing algorithm to a digital luminance image processing algorithm, wherein the luminance representation of the image comprises a single video virtual channel, wherein the single virtual channel is the Y video virtual channel.

5. The method of claim 1, wherein the digital image processing algorithm is a digital color image processing algorithm, the method comprises:
modifying the digital color image processing algorithm to a digital luminance image processing algorithm, wherein the digital luminance image processing algorithm is configured to process an input comprising a single video virtual channel, wherein the single video virtual channel comprises the Y group.

6. The method of claim 1, wherein said obtaining the Y video virtual channel comprises:
obtaining a digital image, wherein the digital image associated with a representation of the image, wherein the Y video virtual channel is based on the digital image.

7. The method of claim 1, wherein the luminance based output comprises a plurality of processed luminance values, wherein the luminance based output comprises an output digital luminance image, wherein the output digital luminance image comprises the plurality of processed luminance values and a plurality of chrominance values, wherein the output digital quasi image comprises an output luminance representation of the image.

8. The method of claim 7, wherein the plurality of chrominance values is based on the image.

9. The method of claim 7, wherein a first chrominance value comprised by the plurality of chrominance values is a constant, wherein the first chrominance value comprised by the plurality of chrominance values is equal to a second chrominance value comprised by the plurality of chrominance values.

10. The method of claim 1, wherein said utilizing the luminance based output comprises providing the luminance based output to a user.

11. The method of claim 1, wherein another Y video virtual channel comprised by the Y group is associated with another digital luminance representation of another image.

12. The method of claim 1, wherein the digital image processing algorithm is configured to process another input, wherein the other input comprises a number of video virtual channels, wherein the digital image processing algorithm is configured to execute a sub processing operation once per each video virtual channel, the method comprises:
executing the sub processing operation once with an input comprising a single video virtual channel, wherein the single video virtual channel is the Y video virtual channel.

13. A computing system comprising:
at least one processor; and
at least one memory communicatively coupled to the at least one processor comprising computer readable instructions that when executed by the at least one processor cause the computing system to perform a method comprising:
obtaining a Y group comprising one or more Y video virtual channels, wherein a Y video virtual channel comprised by the Y group is associated with a digital luminance representation of an image, wherein the Y video virtual channel comprises a plurality of luminance values, wherein a luminance value comprised by the plurality of luminance values is indicative to an intensity of luminance in one or more coordinates in the image;
luminance processing a luminance based input to a luminance based output, wherein the luminance based input comprises the Y group, wherein luminance processing comprises utilizing a digital image processing algorithm with an input comprising the luminance based input, whereby processing the image based on the plurality of luminance values; and
utilizing the luminance based output.

14. The computing system of claim 13, wherein the digital image processing algorithm is configured to process another input, wherein the other input comprises a number of video virtual channels, the method comprises:
obtaining a dummy group, wherein the dummy group is a group comprising another number of dummy virtual channels, wherein the other number of dummy virtual channels is equal to the number minus one, wherein the luminance based input comprises the dummy group, wherein a dummy video virtual channel comprised by the dummy group is selected from a group consisting one of: the Y virtual channel and a zero virtual channel, wherein the zero virtual channel comprises zeros, wherein the number of zeros is equal to the number of luminance's values comprised by the Y virtual channel, wherein the input comprises the Y group and the dummy group.

15. The computing system of claim 14, wherein the digital image processing algorithm is a digital color image processing algorithm configured to color process a color based input, wherein the color based input comprises a digital color representation of the image, wherein the digital color representation of the image comprises a color group, wherein the color group comprises one or more color video virtual channels, wherein color process the color based input comprises invoking the digital color image processing algorithm, wherein said luminance processing comprises invoking the digital color image processing algorithm with the luminance based input.

16. The computing system of claim 13, wherein the digital image processing algorithm is a digital color image processing algorithm configured to color process a color based input, the method comprises:
modifying the digital image processing algorithm to a digital luminance image processing algorithm, wherein the luminance representation of the image comprises a single video virtual channel, wherein the single virtual channel is the Y video virtual channel.

17. The computing system of claim 13, wherein the digital image processing algorithm is a digital color image processing algorithm, the method comprises:
modifying the digital color image processing algorithm to a digital luminance image processing algorithm, wherein the digital luminance image processing algorithm is configured to process an input comprising a single video virtual channel, wherein the single video virtual channel comprises the Y group.

18. The computing system of claim 13, wherein said obtaining the Y video virtual channel comprises:
obtaining a digital image, wherein the digital image associated with a representation of the image, wherein the Y video virtual channel is based on the digital image.

19. The computing system of claim 13, wherein the luminance based output comprises a plurality of processed luminance values, wherein the luminance based output comprises an output digital luminance image, wherein the output digital luminance image comprises the plurality of processed luminance values and a plurality of chrominance values, wherein the output digital quasi image comprises an output luminance representation of the image.

20. The computing system of claim 13, wherein the digital image processing algorithm is configured to process another input, wherein the other input comprises a number of video virtual channels, wherein the digital image processing algorithm is configured to execute a sub processing operation once per each video virtual channel, the method comprises:
executing the sub processing operation once with an input comprising a single video virtual channel, wherein the single video virtual channel is the Y video virtual channel.

21. An apparatus comprising:
a processor and a memory;
wherein the memory is configured to retain one or more video frames, wherein a video frame comprised by the one or more video frames comprises at least a first area of interest in the video frame;
wherein said processor is configured to:
obtaining a Y group comprising one or more Y video virtual channels, wherein a Y video virtual channel comprised by the Y group is associated with a digital luminance representation of an image, wherein the Y video virtual channel comprises a plurality of luminance values, wherein a luminance value comprised by the plurality of luminance values is indicative to an intensity of luminance in one or more coordinates in the image;
luminance processing a luminance based input to a luminance based output, wherein the luminance based input comprises the Y group, wherein luminance processing comprises utilizing a digital image processing algorithm with an input comprising the luminance based input, whereby processing the image based on the plurality of luminance values; and
utilizing the luminance based output.

22. The apparatus of claim 21, wherein the digital image processing algorithm is configured to process another input, wherein the other input comprises a number of video virtual channels, the method comprises:
obtaining a dummy group, wherein the dummy group is a group comprising another number of dummy virtual channels, wherein the other number of dummy virtual channels is equal to the number minus one, wherein the luminance based input comprises the dummy group, wherein a dummy video virtual channel comprised by the dummy group is selected from a group consisting one of: the Y virtual channel and a zero virtual channel, wherein the zero virtual channel comprises zeros, wherein the number of zeros is equal to the number of luminance's values comprised by the Y virtual channel, wherein the input comprises the Y group and the dummy group.

23. The apparatus of claim 22, wherein the digital image processing algorithm is a digital color image processing algorithm configured to color process a color based input, wherein the color based input comprises a digital color representation of the image, wherein the digital color representation of the image comprises a color group, wherein the color group comprises one or more color video virtual channels, wherein color process the color based input comprises invoking the digital color image processing algorithm, wherein said luminance processing comprises invoking the digital color image processing algorithm with the luminance based input.

24. The apparatus of claim 21, wherein the digital image processing algorithm is a digital color image processing algorithm configured to color process a color based input, the method comprises:
modifying the digital image processing algorithm to a digital luminance image processing algorithm, wherein the luminance representation of the image comprises a single video virtual channel, wherein the single virtual channel is the Y video virtual channel.

25. The apparatus of claim 21, wherein the digital image processing algorithm is a digital color image processing algorithm, the method comprises:
modifying the digital color image processing algorithm to a digital luminance image processing algorithm, wherein the digital luminance image processing algorithm is configured to process an input comprising a single video virtual channel, wherein the single video virtual channel comprises the Y group.

26. The apparatus of claim 21, wherein said obtaining the Y video virtual channel comprises:
obtaining a digital image, wherein the digital image associated with a representation of the image, wherein the Y video virtual channel is based on the digital image.

27. The apparatus of claim 21, wherein the luminance based output comprises a plurality of processed luminance values, wherein the luminance based output comprises an output digital luminance image, wherein the output digital luminance image comprises the plurality of processed luminance values and a plurality of chrominance values, wherein the output digital quasi image comprises an output luminance representation of the image.

28. The apparatus of claim 21, wherein the digital image processing algorithm is configured to process another input, wherein the other input comprises a number of video virtual channels, wherein the digital image processing algorithm is configured to execute a sub processing operation once per each video virtual channel, the method comprises:
executing the sub processing operation once with an input comprising a single video virtual channel, wherein the single video virtual channel is the Y video virtual channel.
